(19) United States
(12) Patent Application Publication
(10) Pub. No.: US 2026/0223793 A1
(43) Pub. Date: Aug. 6, 2026

(54) Hydroponic System

(71) Applicant: Michael A. Sanzo, Fernandina Beach, FL (US)

(72) Inventor: Michael A. Sanzo, Fernandina Beach, FL (US)

(21) Appl. No.: 19/449,619

(22) Filed: Jan. 15, 2026

Related U.S. Application Data
(60) Provisional application No. 63/752,712, filed on Feb. 1, 2025.
(60) Provisional application No. 63/908,627, filed on Oct. 30, 2025.

(51) Int. Cl. A01G 31/00; A01G 9/14; A01G 9/24; A01G 31/02

(52) U.S. Cl. CPC A01G 31/008; A01G 9/246; A01G 31/065

(57) ABSTRACT

The present invention is directed to hydroponic systems that can be used in an arid environment with large daily fluctuations in temperature and to the use of those systems for growing plants.

### CROSS REFERENCE TO RELATED APPLICATIONS

This application claims the benefit under 35 U.S.C. § 119 (e) of U.S. Provisional Application No. 63/908,627, filed on Oct. 30, 2025, and the benefit of U.S. 63/752,712, filed on Feb. 1, 2025, the entire disclosures of which are hereby incorporated by reference.

### FIELD OF THE INVENTION

The present invention is directed to hydroponic systems that can be used to grow plants in an arid environment marked by large daily fluctuations in temperature. This environment is typical of many deserts where it is hot during the day but cold at night.

### BACKGROUND OF THE INVENTION

Traditional farming requires a location that offers sunlight, nutrient-rich soil, air, water, and lots of space. However, even when all of these conditions are present, crops can be destroyed by bad weather, drought, insects, and disease. Hydroponic systems have been known for many years and address most of these problems. Sunlight can, if necessary, be supplemented with grow lights, much less water is required, and nutrient levels can be measured and adjusted to promote good growth. In addition, limitations on space can be at least partially solved using vertical systems, and the risk of losses due to insects or disease can be substantially reduced.

Hydroponic systems used indoors are in environments where cold weather or rapid fluctuations in temperature are not a problem. However, this is not true of systems used outdoors. When exposed to such conditions, hydroponic systems must have mechanisms for maintaining an internal environment conducive to plant growth.

The present application is directed to hydroponic systems designed primarily for use in a desert-like area characterized by large daily fluctuations in temperature and a scarcity of water. However, the systems could be used in other environments as well.

### SUMMARY OF THE INVENTION

### Core Hydroponic System

The invention is directed to a hydroponic system designed for arid environments with large diurnal temperature fluctuations. The system includes a support structure (S1, S2A, S2B)) enclosing a plant-growth area (52). This structure is built with translucent polymeric panels (1) that transmit, preferably, between 70% and 95% of sunlight and have a thermal conductivity ranging from 0.05 to 0.4 W/m·K. The combined surface area of the walls and roof of the structure should consist of at least 30% translucent polymeric panels (1).

The system further includes at least one vent (3) with a movable cover (26) and, optionally, an insect screen (24) that covers the gap formed when the vent is open. Air circulation within the support structure may be assisted by one or more fans. A thermostat (30) provides temperature data to a microcontroller (33), which opens or closes the vent cover (26) based on a temperature differential between the internal and external environments or, more generally, whenever the internal temperature falls outside a preset range (e.g., 65-80° F.).

Preferably, the thermostat includes both an internal and an external air temperature sensor. This dual-sensor configuration allows the system to anticipate temperature swings and adjust proactively to maintain stable conditions within the plant-growth area. By referencing both ambient outdoor and internal temperatures, the microcontroller avoids overcompensating with heating or cooling, thereby improving energy efficiency and environmental stability.

The thermostat system should be capable of transmitting temperature data to the microcontroller. Commercially available devices meeting these requirements include the Honeywell TH8321WF1001 Touchscreen Thermostat, the Honeywell Prestige IAQ Thermostat with RedLINK, and the Differential Temperature Controller from Thermomart. Each of these systems supports wireless sensor integration and can communicate indoor and outdoor temperature data to a central controller for automated vent operation.

The hydroponic system further includes a nutrient-delivery subsystem comprising a nutrient fluid reservoir (16), pump (15), and conduits (18, 39, 45) that circulate nutrient fluid through the plant roots in the plant-growth area. After contacting the plant roots, the nutrient fluid exits the plant-growth area and flows through a return conduit leading to a depletion valve (47). This valve selectively directs the returning nutrient fluid either back to the nutrient fluid reservoir (48) or to a waste conduit (49).

The nutrient fluid reservoir (16) may include a mixing device to maintain a uniform nutrient composition. Suitable mixers include low-speed impellers, magnetic-coupling stirrers, or pneumatic injectors that circulate the fluid without excessive aeration. Continuous or intermittent mixing ensures homogeneous distribution of nutrients and prevents stratification or localized depletion. The microcontroller (66) may coordinate mixer operation with replenishment or recirculation cycles to maintain optimal nutrient uniformity.

The system preferably includes one or more growth factor sensors (46a, 46b) positioned to monitor nutrient fluid quality. These sensors measure parameters such as electrical conductivity, pH, dissolved oxygen, and nutrient concentration. Sensor data are transmitted to the microcontroller, which uses the readings to regulate pump speed and depletion valve position. When nutrient depletion is detected, the microcontroller can either increase flow rate to maintain a constant nutrient mass delivery (Q×C, wherein Q is the volumetric flow rate and C is nutrient concentration) or redirect depleted fluid to a waste area (49). Once fluid quality returns to an acceptable range, the valve redirects flow back to the reservoir (16).

In a preferred embodiment, a first growth factor sensor (46b) measures nutrient quality before entry into the plant-growth area (52), while a second sensor (46a) measures corresponding parameters in the effluent. Comparing the two readings allows the system to monitor nutrient utilization and detect potential plant stress or contamination.

Although there is variation, most plants do well when their root temperature is between 65 and 75° F. Being too cold for a sustained period can slow root metabolism, decrease plant efficiency at absorbing water and nutrients, stunt growth and increase disease risk. Being too hot will tend to reduce oxygen availability, potentially kill root cells and create nutrient imbalances. Thus, in a preferred embodiment the hydroponic systems herein have an emergency thermal control subsystem. This will include at least one thermal sensor for measuring nutrient fluid temperature, which may be part of a growth factor sensor also monitoring nutrient fluid growth factors, or constitute a separate sensor dedicated to temperature measurement. In addition, there will be devices for heating or cooling nutrient fluid temperature (H/C). The thermal sensor transmits temperature readings to a microcontroller which, in response to a reading outside of predefined range, will activate either a heating device or cooling device to adjust nutrient fluid temperature and deactivate the device when the temperature is within the predefined range.

### Emergency Thermal Control Subsystem

The invention further includes an emergency thermal control subsystem, which may be incorporated into the hydroponic systems described herein or used as part of a different system. This subsystem comprises: a) at least one thermal sensor that measures the temperature of the nutrient fluid and transmits this data to a microcontroller; b) a microcontroller configured to compare the measured fluid temperature with a predefined range and activate or deactivate the thermal control unit accordingly; and c) a thermal control unit (H/C) that includes one or more of the following devices: i) a submersible heater, ii) an inline chiller, or iii) A dual-function heating and cooling device. The thermal sensor may either be independent or integrated within a growth factor sensor that also measures other nutrient fluid characteristics, such as electrical conductivity, pH, and dissolved oxygen.

When the measured nutrient fluid temperature falls outside the predefined range, the microcontroller activates the thermal control unit. The system deactivates the thermal control unit once the fluid temperature returns to the optimal range. The interaction between the microcontroller and the thermal control unit is facilitated using a solid-state relay, mechanical relay, or pulse-width modulation (PWM) to regulate the heating or cooling function.

### Nutrient Replenishment Subsystem

The invention further includes a nutrient replenishment subsystem that can be used as part of the hydroponic systems described herein or as a standalone component in other systems. This subsystem comprises: a) a nutrient fluid concentrate reservoir (58); b) A water reservoir (57); c) at least one pump (62) connected to both the nutrient fluid concentrate reservoir and the water reservoir; d) a nutrient fluid reservoir (16) that stores and provides nutrient fluid to the plants in the hydroponic system; e) conduits for transporting fluid from both the nutrient fluid concentrate reservoir and the water reservoir to the nutrient fluid reservoir; f) a growth factor sensor (64) positioned after the mixing chamber (63) and before the nutrient fluid reservoir (16); g) a level sensor (65) that monitors the amount of nutrient fluid in the nutrient fluid reservoir; and h) a microcontroller (66), which is programmed to: i) receive data from the level sensor (65) and activate the pump (62) when the nutrient fluid level falls below a preset volume, followed by deactivating the pump when the level reaches or exceeds a second preset volume; and ii) receive data from the growth factor sensor (64) to adjust the relative amounts of water and nutrient fluid concentrate to be mixed and delivered to the nutrient fluid reservoir.

The nutrient fluid replenishment system may also include devices for heating or cooling nutrient fluid temperature (H/C). In these cases, the growth factor sensor (64) may also measure the temperature of nutrient fluid or there may be a separate dedicated thermal sensor. The microcontroller is configured to receive nutrient temperature data from the growth factor sensor (64) or separate thermal sensor and to respond to temperatures outside of a preset range by activating either a heating device or cooling device (H/C) and deactivating the device when nutrient temperatures are within the preset range.

During operation, the nutrient replenishment subsystem continuously monitors the nutrient fluid levels in the nutrient fluid reservoir (16) using the level sensor (65). When the fluid level drops below a preset threshold, the microcontroller (66) activates the pump (62) to draw fluid from the water and nutrient fluid concentrate reservoirs (57, 58). The microcontroller adjusts the flow rate by modulating the position of the replenishment valves (59, 60), ensuring the right mix of water and concentrate is delivered to the nutrient fluid reservoir. The growth factor sensor (64) monitors the quality of the nutrient fluid and provides real-time data to the microcontroller. If the sensor detects that nutrient concentrations fall outside the optimal range, the microcontroller adjusts the flow rate of the replenishment fluids accordingly, ensuring the nutrient solution remains balanced and within the ideal parameters for plant growth.

Additionally, the microcontroller integrates temperature control to ensure the nutrient fluid remains within the desired temperature range. If the temperature falls outside the preset range, either the heating or cooling devices (H/C) are activated based on data from the growth factor or thermal sensor. Once the temperature returns to the optimal range, the microcontroller deactivates the heating or cooling system, ensuring that the root-zone temperature remains stable, thus supporting healthy plant growth.

### Water Recovery Methods

The hydroponic system may include a built-in water recovery system to maximize water efficiency, particularly in arid environments. Spent nutrient fluid that is no longer effective for plant growth is directed to a waste area, where water is recovered using various methods. One preferred method for water recovery is passive solar distillation, which is simple, cost-effective, and ideal for desert-like environments. In this process, the spent nutrient fluid is exposed to solar heat, causing evaporation, and the resulting vapor is condensed into clean water.

Additionally, water can be recovered using membrane filtration techniques, such as reverse osmosis or nanofiltration. In this type of process, nutrient-depleted fluid is pushed through a semipermeable membrane, which separates water from dissolved salts, nutrients, and contaminants. This allows for the purification and reuse of water in the hydroponic system. A pre-filtration step ensures that larger particles and debris are removed before the fluid enters the membrane unit.

The system may also include a rainwater recovery subsystem, where rainwater is collected from the roof of the support structure using rain gutters and downspouts, filtered to remove debris, and stored in a water reservoir for later use. This recovered rainwater can be integrated into the nutrient replenishment system, further enhancing water conservation.

### Methods of Hydroponically Growing Plants

The invention also provides a method of hydroponically growing plants using any of the hydroponic systems or subsystems described herein. In operation, nutrient fluid is circulated from the nutrient fluid reservoir (16) through one or more plant growth conduits (21) so that it contacts the roots of the plants located in the plant-growth area (52). The nutrient fluid exits the plant-growth area and passes one or more growth factor sensors (46a, 46b), which measure parameters such as electrical conductivity, pH, dissolved oxygen, and nutrient concentration.

Data from these sensors are transmitted to the microcontroller (33, 51, or 66), which adjusts pump speed, replenishment valve position, or the depletion valve (47) to maintain a substantially constant nutrient delivery rate and appropriate nutrient concentration. When the nutrient fluid falls outside of a desired quality range, it is automatically directed to a waste area (50), where water may be recovered by passive solar distillation or other treatment methods.

The method further includes maintaining the temperature of both the air within the support structure and the nutrient fluid within preset ranges. Air temperature is regulated by vents (3) with movable covers (26), air temperature sensors associated with a thermostat (30), and a microcontroller (33) that opens or closes the vents in response to temperature differentials. The nutrient fluid temperature is regulated by a thermal control subsystem (H/C) that includes heating and/or cooling devices, which are activated by the microcontroller when sensor readings indicate temperatures outside the desired range.

Together, these steps maintain optimal environmental and nutrient conditions, allowing the plants to grow efficiently in arid regions characterized by large diurnal temperature fluctuations.

### Adaptive Regulation of Systems

The hydroponic subsystems described herein, as well as other systems having a recirculating hydroponic loop comprising a nutrient reservoir (16), a supply conduit, a plant-growth region, and a return conduit, may employ adaptive regulation to maintain stable growing conditions despite external or internal fluctuations.

Adaptive regulation involves providing a microcontroller with signals from sensors positioned before and after the plant-growth region (46a, 46b). These sensors convey information on nutrient-fluid temperature and electrical conductivity (EC). From these signals, the microcontroller determines (i) a temperature differential between the supply and return conduits and (ii) an EC differential between the reservoir and the return conduit. Based on these differentials, the microcontroller operates one or more actuators selected from a circulation pump (15), a temperature-conditioning device (H/C), and a splitter or depletion valve (47) configured to direct a purge fraction either to waste or to the reservoir. The microcontroller operates these actuators in accordance with stored control rules that reduce the measured differential toward a defined target value.

After each actuator operation, the microcontroller monitors the subsequent sensor responses and adapts one or more control parameters, such as H/C on-time, pump-speed setpoint, or valve (47) positioning, to minimize overshoot and stabilize system response. In this way, the hydroponic system self-tunes to maintain environmental conditions within target ranges while minimizing waste and power consumption. For example, the microcontroller may increase H/C on-time when the supply-to-return temperature differential exceeds a threshold, and adjust valve (47) position to compensate for cumulative EC deviation.

Adaptive regulation may further integrate data from a thermostat (30) that provides both inside-air temperature and outside-air temperature-trend information. The micro-controller coordinates operation of vents (28) and fans (20) with that of the temperature-conditioning device (H/C) to reduce a composite deviation, a weighted combination of (a) the difference between indoor and outdoor air temperature and (b) the supply-to-return nutrient-temperature differential. In one mode, the microcontroller increases H/C activation time and pump speed in anticipation of a rising outside air temperature while incrementally opening vents (28), and subsequently reduces H/C activation time when the measured supply-to-return temperature differential falls below a threshold.

Adaptive control may also be applied in systems that include a replenishment subsystem. In such embodiments, the microcontroller receives additional signals from an upstream growth-factor sensor (64) located after the mixing chamber (63). Using the combined data from sensors (46a, 46b, and 64), the microcontroller determines differentials in both temperature and EC, and operates one or more actuators selected from the circulation pump (15), temperature-conditioning device (H/C), depletion valve (47), and replenishment controls such as pump (62) and replenishment valves (59, 60) in accordance with control rules designed to reduce deviations toward preset targets.

After each cycle, the system updates at least one control parameter, including H/C on-time, pump flow rate, valve (47) position, or the replenishment-valve mixing ratio, based on the measured sensor responses. In this manner, the system continuously adjusts itself to maintain optimal thermal and nutrient conditions with minimal overshoot. Representative responses include increasing H/C activation time when the supply-to-return temperature differential exceeds a threshold and adjusting valve 47 to compensate for cumulative EC deviation; and modifying the replenishment mixing ratio of valves (59, 60) in response to EC deviation while concurrently limiting waste through valve (47) adjustment when evaporative events are inferred from an indoor-air temperature rise accompanied by a reservoir-level drop.

### Advantages

The hydroponic systems described herein provide reliable plant growth in environments characterized by large diurnal temperature fluctuations and limited water availability. The systems maintain stable root-zone conditions through automated temperature regulation of both air and nutrient fluid, thereby reducing plant stress and promoting consistent growth.

Water conservation is achieved through selective purge control, nutrient-fluid recycling, and water recovery from waste streams using passive solar distillation or membrane filtration. Optional rainwater collection and reuse further reduce the need for external water input, making the system particularly well suited for arid and semi-arid regions.

The integration of multiple sensors and a programmable microcontroller allows for continuous monitoring of key growth parameters, including nutrient concentration, pH, dissolved oxygen, temperature, and fluid level. This feedback-driven control maintains optimal conditions automatically and with minimal human intervention.

The modular design enables scalability, from small, manually operated units suitable for individual users to large, fully automated installations for commercial or community-scale production. The use of translucent polymeric panels and energy-efficient control algorithms further reduce operational costs while supporting sustainable cultivation in areas where traditional agriculture is impractical.

Collectively, these features make the system energy-efficient, water-conserving, and adaptable, providing a robust and sustainable method for producing crops year-round in challenging environments.

### BRIEF DESCRIPTION OF THE DRAWINGS

The description and claims below include many reference numeral identifiers that refer to elements in Figures. These identifiers are used solely to help in understanding the invention. They are not intended to limit the invention specifically to the elements shown. For an identification of each reference numeral and the figure where it first appears, see Table 1.

FIG. 1: FIG. 1 is a perspective view of a support structure (S1) having a gabled roof. The roof and walls are constructed primarily of translucent polymeric panels (1) that transmit 70-95% of sunlight while providing thermal insulation. The structure defines an internal plant-growth area suitable for maintaining controlled environmental conditions.

FIG. 2A and FIG. 2B: FIGS. 2A and 2B show alternative embodiments of support structures suitable for the hydroponic system. Each structure encloses a plant-growth area and includes translucent polymeric panels (1) that transmit sunlight while insulating the interior. In FIG. 2A, the structure (S2A) has arched rafters and an arched roof formed of polymeric panels.

In FIG. 2B, the lower wall portions are constructed from thermally insulating masonry or similar non-polymeric material (14a), while the upper wall and roof sections remain translucent to permit light transmission. These figures illustrate variations that provide equivalent environmental control with different structural materials and roof geometries.

FIG. 3: FIG. 3: is a cutaway view showing components located within the inner enclosed space (S3) of a support structure (S1, S2A, or S2B). The figure illustrates a representative arrangement of major hydroponic elements, including the nutrient fluid reservoir (16), pump (15), conduits (18), plant growth conduits (21), and associated environmental control components. The thermostat (30) includes internal and external air temperature sensors that transmit data to a microcontroller (33), which operates a movable vent cover (26) and optional fan (31) to regulate internal temperature. For simplicity, the roof is omitted to reveal the arrangement of the internal elements.

FIG. 4: FIG. 4 illustrates the nutrient delivery subsystem (S4) that circulates nutrient fluid through the plant-growth area (52). Nutrient fluid is pumped from the nutrient fluid reservoir (16) by pump (15) through conduits (18, 39, 45) into the plant growth conduits (21), where it contacts the roots of plants positioned in openings along the top surfaces of the conduits (see FIG. 3). The fluid then exits the plant-growth area (44) and passes a first growth factor sensor (46a), which measures parameters such as electrical conductivity, pH, dissolved oxygen, and nutrient concentration to determine whether the nutrient fluid remains effective for plant growth.

Data from the growth factor sensor (46a) are transmitted to a microcontroller (51), which regulates the position of a depletion valve (47) located in the nutrient return path. Depending on sensor readings, the microcontroller directs the nutrient fluid either through a return conduit (48) to the nutrient reservoir (16) or through a waste conduit (49) to a waste area (50). The microcontroller may also adjust pump speed to maintain a substantially constant nutrient mass delivery rate (Q×C), where Q is the volumetric flow rate and C is nutrient concentration.

FIG. 5: FIG. 5 illustrates a passive solar distillation system (S5) for recovering water from nutrient fluid that has been diverted to the waste area (50). The spent nutrient fluid flows into a waste tray (53) positioned to receive direct sunlight. Heat from solar radiation causes the fluid to evaporate, and the vapor condenses on an inclined condensation panel (54). The condensed water then runs downward into a condensation gutter (55) and through a conduit (56) to a clean-water reservoir (57). The recovered water may subsequently be reused in the hydroponic system's replenishment subsystem (see FIG. 6). This embodiment demonstrates how the hydroponic system conserves water by reclaiming it from spent nutrient fluid, enabling sustainable operation in arid environments with minimal external water input.

FIG. 6: FIG. 6 illustrates the automated nutrient fluid replenishment subsystem (S6). This subsystem restores the nutrient fluid in the main reservoir (16) when levels fall below a preset threshold and automatically adjusts nutrient concentration to maintain optimal growth conditions. The system includes a water reservoir (57), a nutrient fluid concentrate reservoir (58), and two replenishment valves (59, 60) that regulate fluid flow from each reservoir into a manifold (61). A pump (62) delivers the combined fluids from the manifold to a mixing chamber (63), where static mixers ensure homogeneity.

Downstream of the mixing chamber, a growth factor sensor (64) measures parameters such as electrical conductivity, pH, dissolved oxygen, and temperature. These readings are transmitted to a microcontroller (66), which adjusts the positions of replenishment valves (59, 60) or the speed of pump (62) to maintain the target nutrient balance. A level sensor (65) located in the nutrient fluid reservoir (16) signals when replenishment is needed and stops the pump once the desired fluid level is restored.

The subsystem may also include a heating/cooling device (H/C) controlled by the microcontroller to ensure that the replenished nutrient fluid is within the desired temperature range. Together, these components maintain nutrient composition, fluid volume, and temperature automatically, reducing the need for manual adjustment and improving system efficiency.

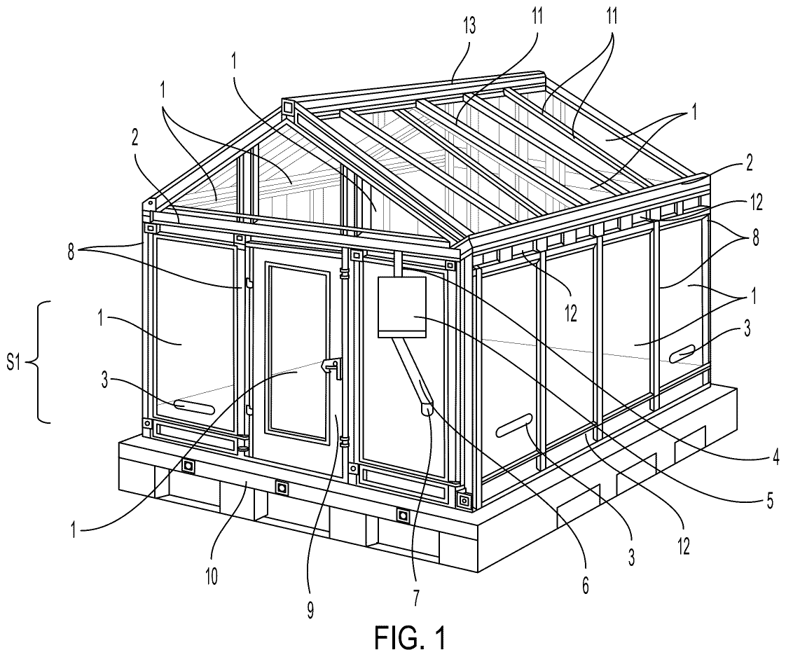

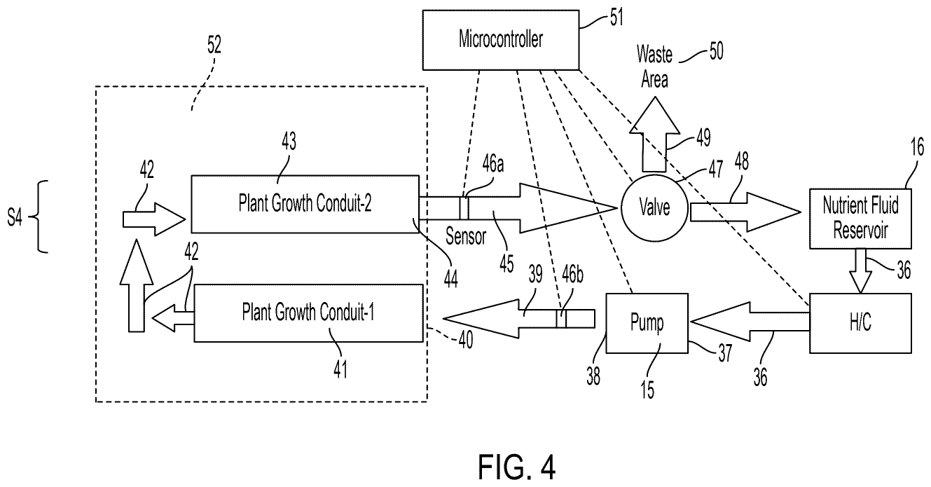

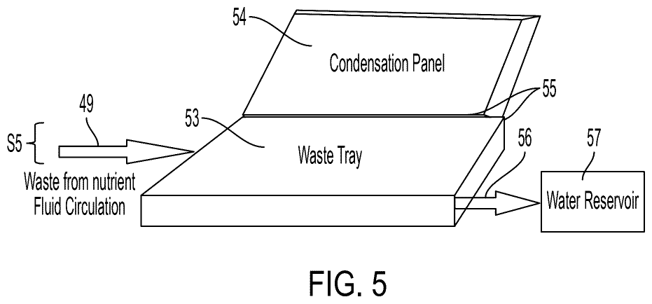

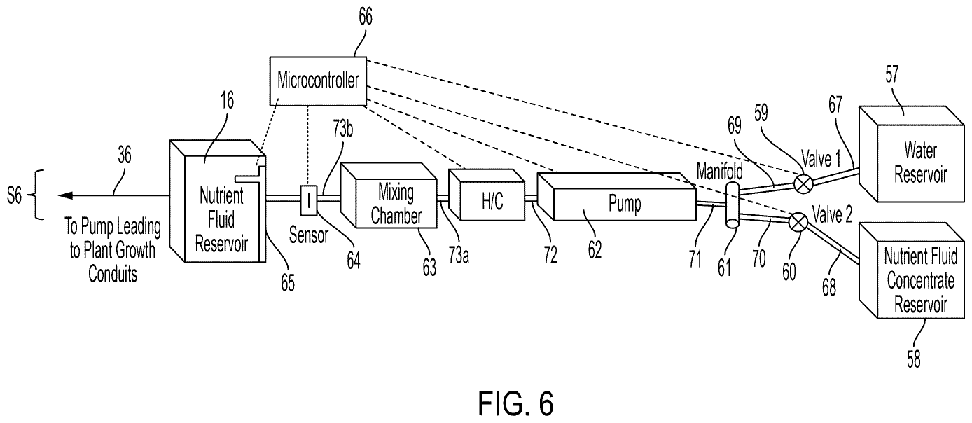

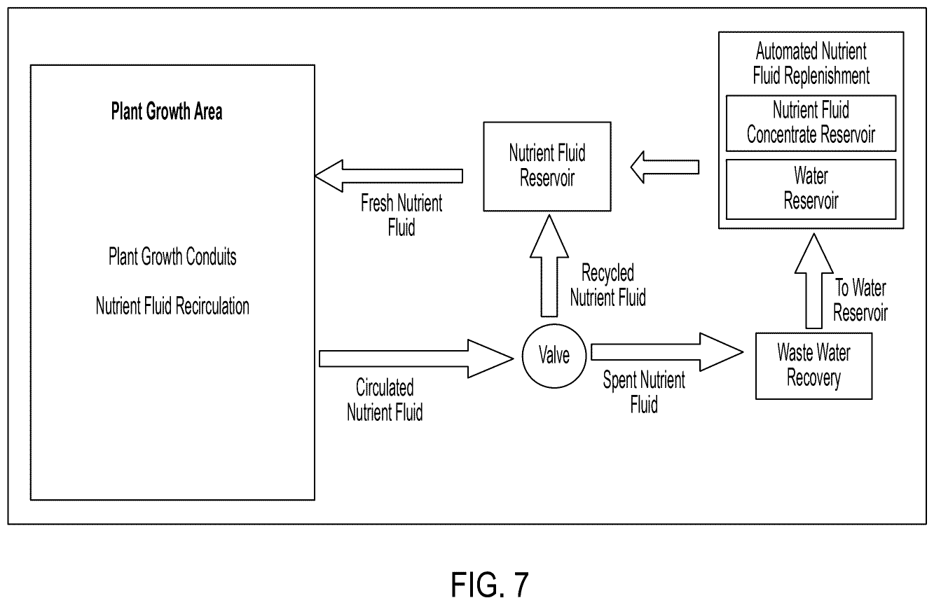

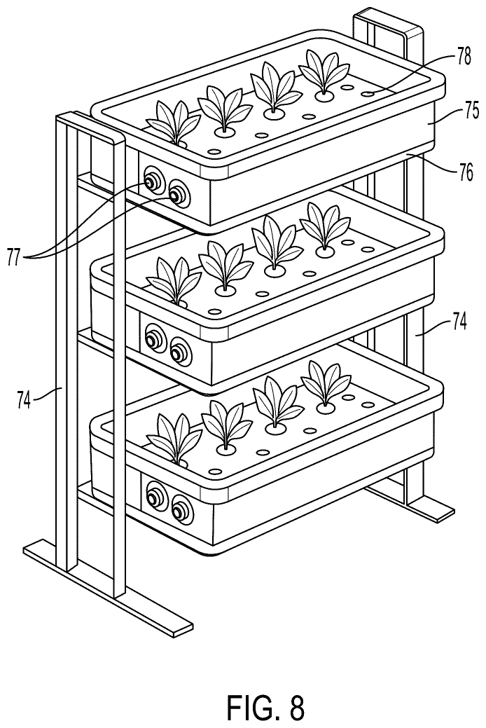

FIG. 7: FIG. 7 provides a schematic overview of the integrated hydroponic system. It illustrates the functional relationships among the main subsystems: the support structure and environmental control system (FIGS. 1-3), the nutrient delivery subsystem (FIG. 4), the water recovery subsystem (FIG. 5), and the automated nutrient replenishment subsystem (FIG. 6). The figure shows how the nutrient fluid circulates from the reservoir (16) through the plant-growth area (52), is monitored by growth factor sensors (46a, 46b), and is routed by the depletion valve (47) either back to the reservoir or to the waste area (50) for water recovery.

It also depicts the connections among the microcontroller (33, 51, 66), the air temperature sensors associated with the thermostat (30), the thermal control unit (H/C), and the various pumps, valves, and sensors that regulate temperature, nutrient concentration, and fluid level. This figure demonstrates how data from multiple sensors are integrated by the microcontroller to maintain stable, automated operation of the system under varying environmental conditions.

FIG. 8: FIG. 8 is a perspective view illustrating a stackable hydroponic embodiment in which a plurality of plant-growth modules (75) are vertically arranged on a supporting frame (74). Each module includes a support surface with integrated grow-light assemblies (76), a plant-support surface (78) positioned above, and quick-connect ports (77) that permit mechanical and fluidic coupling between adjacent modules to form a scalable, multi-level hydroponic system.

FIGS. 1-6 include numerous reference numerals that are identified in Table: 1

TABLE 1
Components Identified in Figures

| | |
|---|---|
| Reference | |
| Identifier | Description |

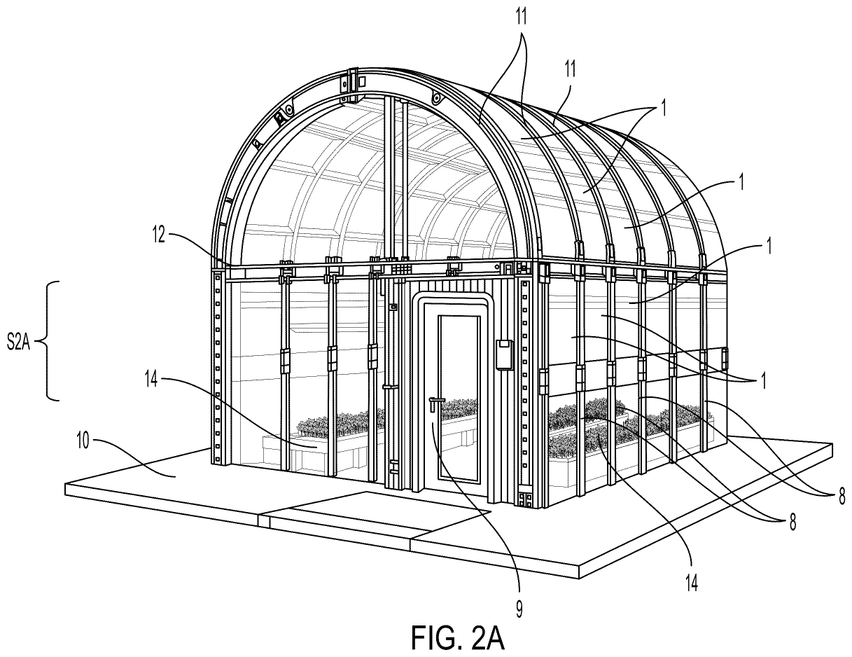

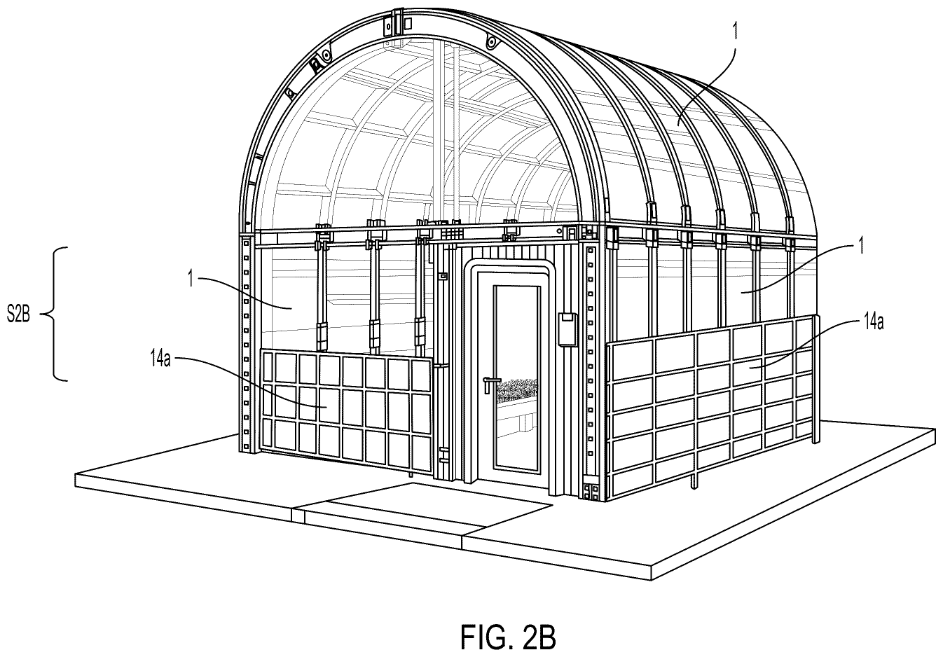

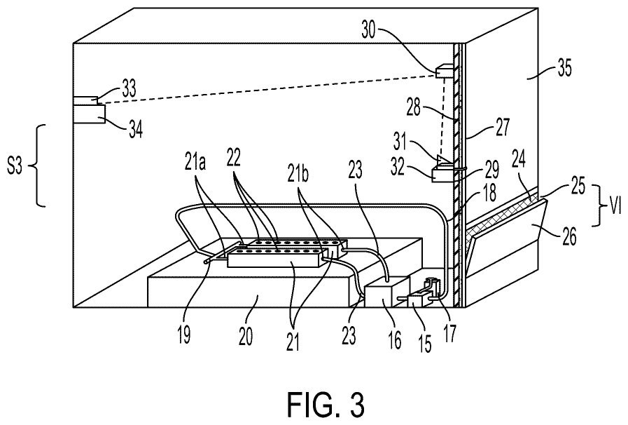

FIGS. 1, 2A and 2B

| | |
|---|---|
| S1 | Support structure with a gable roof and polymeric walls. |
| S2A | Support structure with arched rafters and an arched roof. |
| | Also, with polymeric walls. |
| S2B | S2B is like S2 except that the lower portion of the walls are |
| | made of non-polymeric material. |
| 1 | Translucent, preferably double-walled, polymeric sheets |
| | supported by a frame and making up the walls of support |
| | structures. |
| 2 | Rain gutters for collecting rain running off the roof and |
| | channeling it to a water reservoir. |
| 3 | Vents. See also V1 in FIG. 3, which shows a vent in an open |
| | position with a moveable cover and an insect screen |
| | covering the gap formed when the vent is open. |
| 4 | Downspout from rain gutters fluidically connecting the |
| | rain gutters with a water reservoir. |
| 5 | Water reservoir. This may be either inside or outside the |
| | support structure. In the example of FIG. 1, it is outside and |
| | high enough to feed water to a user by gravity. |
| 6 | Downspout from the water reservoir to inside the support |
| | structure. This should terminate in a valve, faucet, or clamp, |
| | allowing a user to obtain water when needed. |
| 7 | Port on a support structure wall allowing downspout (6) to |
| | transfer water into the support structure. |
| 8 | Columns that are part of the framework of the support |
| | structure. These, with framework beams, support the walls. |
| 9 | Door leading inside the support structure. |
| 10 | A base that may be used to anchor the walls and roof of the |
| | support structure. This can form a floor for the support |
| | structure, or a separate floor can be present. |
| 11 | Roof rafters. These may either be linear, as shown in FIG. 1, |
| | or arched, as shown in FIGS. 2A and 2B. |
| 12 | Beams of framework. |
| 13 | Roof ridge for a gable roof. |
| 14 | Plants growing inside a support structure. |
| 14a | Alternative building materials that may be used for parts of |
| | walls. This may be brick, concrete blocks, or some other |
| | material with good thermal insulation characteristics. |

FIG. 3

| | |
|---|---|
| S3 | Inner enclosed space of support structure showing some |
| | components needed for hydroponics. |
| 15 | Fluid pump. |
| 16 | Nutrient fluid reservoir. Optionally, an air pump and air |
| | stones may be present in the reservoir to increase the |
| | amount of dissolved oxygen in the nutrient fluid. |
| 17 | Battery. |
| 18 | Conduit for delivering nutrient fluid from the nutrient fluid |
| | reservoir to the fluid receiving end of the plant growth |
| | conduits. This may optionally connect with ports aiding |
| | flow into a channel inside the conduits. In the example, the |
| | plant growth conduits are parallel, i.e., the fluid passes |
| | through one conduit and then returns. The conduits, or |
| | other sites of plant growth, can also be arranged in series, |
| | e.g., nutrient fluid passes from one plant growth conduit to |
| | one or more different plant growth conduits before |
| | recirculation back to the nutrient fluid reservoir or to |
| | waste area (see FIG. 4). |
| 19 | Manifold at the fluid receiving end of the plant growth |
| | channel. |
| 20 | Support table for plant growth conduits. |
| 21 | Plant growth conduits with a fluid entry site at one end |
| | and a fluid exit site at the other. |
| 21a | Fluid entry site of plant growth conduits. |
| 21b | Fluid exit site of plant growth conduits. |
| 22 | Openings in the upper surface of the plant growth conduits |
| | which may hold pots or other vessels for growing plants. |
| | The tops of the plants are positioned to receive sunlight, |
| | and the roots of the plants extend into the plant growth |
| | conduit to contact flowing nutrient fluid. |
| 23 | Conduits in which fluid is transferred from the fluid exit |
| | site of plant growth conduits to the nutrient fluid reservoir. |
| V1 | 24, 25, and 26 show an example vent that includes a gap |
| | formed when the vent is open, an insect screen that covers |
| | the gap, and a moveable cover, which, in the example, is |
| | in a partially open position. |
| 24 | Insect screen covering the gap formed when the vent is |
| | open and having a mesh that inhibits the passage of dirt, |
| | dust and insects but permits the passage of air. One |
| | option, polyester screens, maintain good airflow, ensuring |
| | a space remains well-ventilated. Polyester is also strong |
| | and weather-resistant, making it suitable for a desert-like |
| | environment. Other materials that may be used include |
| | aluminum, stainless steel and fiberglass. |
| 25 | Gap created by opening the moveable vent cover. |
| 26 | Moveable cover of vent. |
| 27 | Outer wall of double walled polymeric sheet that may be |
| | used in the walls and roofs of support structures. |
| 28 | Inner wall of the double-walled polymeric sheet used in |
| | the walls and roofs of support structures. |
| 29 | Space between the outer and inner walls of the double- |
| | walled polymeric sheets. This is preferably filled with a |
| | transparent or translucent insulating material such as an |
| | aerogel, insulating gas, or phase change material. |
| 30 | Thermostat, which controls the opening and closing of |
| | vents and is in communication with a microcontroller. |
| | Preferably, this is a thermostat that simultaneously |
| | measures both the temperature inside the support |
| | structure and the temperature of the environment |
| | outside the support structure. |
| 31 | Optional fan that is also under the control of the |
| | microcontroller. The fan may be activated when the vent |
| | is opened and deactivated when the vent is closed. |
| | However, fans can also be activated and deactivated |
| | independently of the positioning of vents. |
| 32 | Support shelf for a fan. |
| 33 | Microcontroller. The microcontroller opens and closes |
| | vents. A single microcontroller may perform all the |
| | functions disclosed in FIGS. 3, 4 and 6 or multiple |
| | microcontrollers can be used. |
| 34 | Support shelf for microcontroller. |
| 35 | Outer surface of outer wall of double walled polymeric |
| | sheets. |

FIG. 4

| | |
|---|---|
| S4 | Nutrient fluid flow. |
| 36 | Arrows representing conduits and showing the direction |
| | of fluid flow from the nutrient fluid reservoir (16) to the |
| | to the fluid entry end (37) of the pump (15). |
| 37 | Fluid entry end of the pump. |
| 38 | Fluid exit end of the pump. |
| 39 | Conduit from the fluid exit end of the pump to the fluid |
| | entry site of the plant growth area. In the example, the |
| | fluid entry site to the plant growth area is at the fluid entry |
| | site of the first plant growth conduit in the plant growth |
| | area. |
| 40 | Fluid entry site to the plant growth area. This is the place |
| | where the nutrient fluid first enters the sites where plants |
| | are growing. In the Example, this is also the fluid entry |
| | site of plant growth conduit-1. |
| 41 | First plant growth conduit in the plant growth area “Plant |
| | Growth Conduit-1.” |
| 42 | Conduits transferring nutrient fluid from plant “Growth |
| | Conduit-1” to “Plant Growth Conduit-2.” |
| 43 | Plant Growth Conduit-2. This is in series with Plant |
| | Growth Conduit 1 and, in the Example, it is the final |
| | plant growth site in the plant growth area. |
| 44 | Fluid exit site of Plant Growth Area. In the Example, this is |
| | also the fluid exit site for the “Plant Growth Conduit-2.” |
| 45 | Conduit transferring nutrient fluid from the Plant Growth |
| | Area to a depletion valve (47). |
| 46a | Growth Factor Sensor monitoring fluid to determine the |
| | quality of the nutrient fluid exiting the plant growth area. |
| | This sensor may take measurements of pH, electrical |
| | conductivity, dissolved oxygen, and/or measurements of |
| | particular nutrients. These measurements are conveyed |
| | to a microcontroller (51). |
| 47 | Depletion valve. In response to signals from the |
| | microcontroller, the valve directs fluid either to a waste |
| | area (50) or back to the nutrient fluid reservoir (16). |
| 48 | Conduit transferring fluid from the depletion valve (47) |
| | to the nutrient fluid reservoir (16). |
| 49 | Conduit transferring fluid from the depletion valve (47) |
| | to the nutrient fluid waste area (50). |
| 50 | Waste Area. This may contain a drain to remove fluid |
| | from the support structure, a container for storing waste |
| | fluid. The waste area may include a system for recovering |
| | water from spent nutrient fluid, i.e., nutrient fluid |
| | determined to be unfit for plant growth. |
| 51 | Microcontroller. This may be the same microcontroller |
| | shown in FIG. 3 and/or FIG. 6 or a different microcontroller. |
| | A single microcontroller may perform all the functions |
| | disclosed in FIGS. 3, 4 and 6 or multiple microcontrollers |
| | can be used. |
| 52 | Plant Growth Area. This is the location in the support |
| | structure where plants are grown. |
| 46b | Growth Factor Sensor monitoring fluid to determine |
| | the quality of the nutrient fluid coming from the |
| | nutrient reservoir. This sensor may take measurements |
| | of pH, electrical conductivity, dissolved oxygen, and/or |
| | measurements of particular nutrients. These measurements |
| | are conveyed to a microcontroller (51). |
| H/C | Emergency heating/cooling components which are under |
| | the control of and activated by the microcontroller in |
| | response to temperature readings by one or more thermal |
| | sensors indicating that nutrient fluid is outside the limits |
| | of a preset temperature range, e.g., 65-75° F. |

FIG. 5

| | |
|---|---|
| S5 | Solar Distillation System: The essential components of |
| | a solar distillation system are shown in FIG. 5. |
| 53 | Waste Tray which receives waste from depletion valve |
| | (47). The waste tray should be positioned to receive |
| | sunlight. |
| 54 | Condensation panel. In the example, this is shown as |
| | being angled away from the waste tray to allow water |
| | to run down its surface and into a condensation gutter |
| | (55). Certain surfaces, such as glass, may cover the waste |
| | tray and retain condensed water by adhesion. |
| 55 | Condensation gutters. These collect condensate and |
| | channel it to a water reservoir. |
| 56 | Conduit channeling condensate to a water reservoir. |
| 57 | Water reservoir. This may optionally be aerated using |
| | an air pump |

FIG. 6

| | |
|---|---|
| S6 | Automated nutrient fluid replenishment system. |
| 58 | Nutrient Fluid Concentrate Reservoir. This contains |
| | concentrated nutrient fluid, which will be diluted with |
| | water from the Water Reservoir to replenish the |
| | nutrient fluid reservoir. Optionally, an air pump and |
| | air stones may be present in the reservoir to increase the |
| | amount of dissolved oxygen in the nutrient fluid |
| | concentrate. |
| 59 | Replenishment Valve 1. This is between the water reservoir |
| | and manifold (61). The valve is under the control of |
| | signals from a microcontroller and regulates the flow |
| | rate of water to the manifold. |
| 60 | Replenishment Valve 2. This is between the Nutrient |
| | Fluid Concentrate Reservoir and the manifold (61). |
| | This valve is under the control of signals from |
| | a microcontroller and regulates the flow rate of nutrient |
| | fluid concentrate to the manifold. |
| 61 | Manifold. Here, water and nutrient fluid concentrate are |
| | fed to pump (62). |
| 62 | Pump. The pump is under the control of the microcontroller |
| | and feeds fluid to a Mixing Chamber (63) with static mixers. |
| 63 | Mixing chamber, which mixes the fluids. The mixed fluid |
| | then travels past a growth factor sensor (64) and into the |
| | nutrient fluid reservoir. |
| 64 | Growth Factor Sensor monitoring fluid from the Mixing |
| | Chamber. The sensor will measure characteristics (e.g., |
| | pH, EC, and dissolved oxygen) to determine if the water |
| | and nutrient fluid concentrate have been properly mixed |
| | to produce nutrient fluid. The measurements are |
| | transmitted to the microcontroller (66), which signals |
| | replenishment valve 1 and replenishment valve 2 to |
| | make any adjustments needed. |
| 65 | Fluid level (float) sensor located inside the nutrient fluid |
| | reservoir (16) and in communication with the |
| | microcontroller. |
| 66 | Microcontroller. The microcontroller receives signals from |
| | the level sensor and sensor analyzing fluid from the |
| | mixing chamber. It uses these signals to determine when |
| | the pump should be turned on and off and how the |
| | replenishment valves controlling the flow from the Water |
| | Reservoir and Nutrient Fluid Concentrate should be |
| | adjusted. A single microcontroller may perform all the |
| | functions disclosed in FIGS. 3, 4 and 6 or multiple |
| | microcontrollers can be used. |
| 67 | Conduit fluidically connecting Water Reservoir (57) with |
| | replenishment valve 1 (59). |
| 68 | Conduit fluidically connecting Nutrient Fluid Concentrate |
| | Reservoir (58) with replenishment valve 2 (60). |
| 69 | Conduit fluidically connecting replenishment valve 1 (59) |
| | with Manifold (61). |
| 70 | Conduit fluidically connecting replenishment valve 2 (60) |
| | with Manifold (61). |
| 71 | Conduit fluidically connecting Manifold (61) with Pump (62). |
| 72 | Conduit fluidically connecting Pump (62) with Emergency |
| | heating/cooling system (H/C). |
| 73a | Conduit fluidically connecting H/C unit to Mixing Chamber . |
| 73b | Conduit fluidically connecting H/C unit to Nutrient Fluid |
| | Reservoir (16) |

FIG. 8

| | |
|---|---|
| 74 | Vertical Frame. This is a rigid structural framework |
| | configured to support a plurality of vertically spaced |
| | plant-growth modules. The vertical frame may include |
| | upright members, cross-braces, and mounting interfaces |
| | that maintain alignment of stacked modules and provide |
| | conduits or channels for routing electrical wiring, data |
| | cables, or nutrient supply lines. The frame may be |
| | fabricated from metal, composite, or polymer materials |
| | with sufficient load-bearing strength to support the |
| | combined weight of the modules and associated fluid |
| | contents. |
| 75 | Stackable plant growth modules. These are essentially |
| | self-contained hydroponic units dimensioned for |
| | mechanical coupling to adjacent modules in a vertical |
| | array. Each module includes at least one plant support |
| | surface and associated nutrient delivery components, |
| | and is equipped with standardized mechanical, fluidic, |
| | and electrical connection points to allow stacking or |
| | interconnection. Modules may be identical or |
| | interchangeable to permit expansion or reconfiguration |
| | of the overall system. |
| 76 | Support surface with grow lights. These are shelves or |
| | platforms forming the lower surface of each module, |
| | and incorporating one or more grow-light |
| | assemblies positioned to illuminate the plant support |
| | surface of the module immediately below. The support |
| | surface may include integral wiring harnesses, heat |
| | sinks, or reflective panels to optimize light distribution and |
| | thermal management within the stacked arrangement. |
| 77 | Quick connect ports. These are interfaces providing rapid |
| | coupling of nutrient supply and return lines, as well as |
| | optional electrical or data connections, between adjacent |
| | modules. Each port may include sealing elements, |
| | alignment features, and automatic shutoff valves that |
| | enable connection or disconnection without leakage or |
| | electrical shorting, thereby allowing individual modules to |
| | be removed or replaced without disturbing the remainder |
| | of the stack. |
| 78 | Plant growth surface. The upper surface of each plant-growth |
| | module is configured to support plant root structures and |
| | retain the nutrient solution or growth medium. The surface |
| | may be flat, contoured, or channelized to promote even |
| | fluid distribution and aeration, and may include apertures |
| | or inserts for receiving plant baskets or plugs. The plant |
| | support surface cooperates with the grow-light assembly |
| | of the adjacent module to maintain uniform illumination |
| | and growth conditions throughout the stack. |

### DEFINITIONS

Hydroponic(s): The term “hydroponic(s)” refers to a method of cultivating plants in which nutrients are supplied in a fluid medium without the use of soil. In the context of the present invention, hydroponics encompasses both passive and actively controlled systems in which nutrient composition, temperature, and oxygenation are automatically regulated by one or more sensors and a microcontroller to sustain plant growth in a controlled environment. Background references describing general hydroponic practice include: Raviv, et al., Soilless Culture Theory and Practice, 2^{nd} edition, Academic Press, Cambridge, MA (2019); Geilfus, Christoph-Martin, Controlled Environment Horticulture: Improving Quality of Vegetables and Medicinal Plants, 1st ed., Springer (2019); and Jones, J. Benton, Jr., Complete Guide for Growing Plants Hydroponically, CRC Press (2014).

Hydroponic System: This term is similar to the one immediately above. As used herein, it refers to a method of cultivating plants in which nutrients are supplied in a fluid medium, without the use of soil, using a system of components that work together to maintain optimal plant growth conditions. As applied to the present invention, these components may include a support structure, a nutrient-delivery subsystem, sensors for monitoring environmental factors (e.g., air and nutrient fluid temperature, nutrient concentration, pH, dissolved oxygen), a microcontroller for system automation, and a water-recovery subsystem. The system automatically regulates nutrient flow, temperature, and fluid levels to support plant growth in controlled environments, particularly in regions with large temperature fluctuations and water scarcity.

Nutrient Fluid: Nutrient fluid is a mixture containing essential nutrients dissolved in water, used to nourish plants in hydroponic systems. The composition of the nutrient fluid is typically adjusted to meet the specific needs of different plant varieties and may be formulated before use or stored in a ready-to-use form. Nutrient fluids are monitored for key characteristics such as nutrient concentration, pH, and dissolved oxygen, all of which are critical to plant health. In the present invention, nutrient fluid temperature is preferably maintained between 65° F. and 75° F. (18-24° C.) to support optimal root-zone metabolism, and the fluid pH is generally kept near neutral (around 6.0-7.0). The system uses growth factor sensors to monitor the nutrient fluid, and the microcontroller automatically adjusts fluid flow and composition to ensure optimal conditions for plant growth.

Support Structure: This term refers to any enclosure that defines an internal space for hydroponics, separated from the outside environment and designed to support plant growth under controlled conditions

Sheets/Panels: The term “sheets” refers to planar, generally rectangular structures used to form the walls and roof of the support structure. The term panel is often used interchangeably with sheet to describe smaller sections of the larger panels. In the context of the present invention, polymeric sheets and panels are made from materials such as polycarbonate or polyethylene, which transmit sunlight while providing thermal insulation. These materials may also include fiberglass, acrylic, or other sturdy materials that are resistant to environmental conditions such as UV radiation and temperature fluctuations. Panels with low thermal conductivity are preferred, and some may incorporate insulating materials such as aerogels or phase change materials to further regulate internal temperature and improve energy efficiency.

Movable Covers: This term refers to coverings used in connection with vents (3, 26) that can be opened or closed to regulate airflow within the support structure. The primary function of these covers is to seal the gap formed when the vent is opened, ensuring that the vent is either fully closed to retain internal heat or opened to allow air exchange with the external environment. Automated movable covers are preferred, particularly those that can be controlled by the microcontroller (33) based on temperature readings from air temperature sensors (30). These covers help to insulate the support structure when closed, reducing heat loss and improving energy efficiency.

Insect Screen: This term refers to a mesh screen used to cover vents (3, 26) and prevent the entry of insects, dust, and debris while still allowing air to flow through. The screen must completely span the gap created when a vent is open. Materials such as polyester, stainless steel, or fiberglass are typically used, with pore sizes ranging from 0.4 to 1 mm (e.g., a 20×20 mesh). The insect screen is designed to integrate with the movable covers (26) and support the internal climate control by maintaining airflow while preventing contamination from external sources.

Plant Growth Conduits: Plant growth conduits are structures used to support plants and deliver nutrient fluid to their roots in a hydroponic system. Some conduits (21) may be rectangular or channel-like and feature openings on the top for placing pots or other plant vessels. The conduits serve a dual function: they provide a stable support for the plant vessels while exposing the plant roots to circulating nutrient fluid. Nutrient fluid is pumped from the nutrient fluid reservoir (16) through the conduits, where it flows along the length of a growth channel and directly contacts the plant roots. The fluid flow is distributed evenly to each plant growth conduit via a manifold (19) located at the fluid entry point. These conduits are integral to the nutrient delivery subsystem (S4) and are designed to optimize both plant support and nutrient delivery.

Pump: As used herein, the term “pump” refers to any device used to propel nutrient fluid through the hydroponic system, ensuring it circulates from the nutrient fluid reservoir (16) to the plant-growth area (52). Preferred pumps include diaphragm pumps, submersible pumps, and peristaltic pumps, which provide reliable and efficient fluid movement. The pump is controlled by the microcontroller (33), which adjusts its speed or activation based on sensor feedback to maintain consistent fluid flow and nutrient delivery. In some embodiments, fluid may alternatively be propelled using pressurized gas.

Aeration: In the context of the present invention this term refers to the process of supplying air to plants, both atmospherically and within the nutrient fluid. In hydroponic systems, aeration is critical for maintaining optimal dissolved oxygen levels in the nutrient fluid, which is essential for healthy root metabolism. Aeration may be provided by an air pump located in the nutrient fluid reservoir (16), typically supplying between 0.5 to 2 liters of air per minute for every 4 liters of nutrient fluid. The air pump may be used in conjunction with air stones or diffusers to ensure even distribution of oxygen throughout the nutrient fluid. In the present system, aeration may also be controlled by the microcontroller (33) working in conjunction with an air pump to maintain consistent oxygenation levels in response to sensor readings from growth factor sensors (46a, 46b).

Microcontroller: As used herein, a “microcontroller” refers to a compact integrated circuit that governs and automates the operation of the hydroponic system. The microcontroller (33) is responsible for processing data from a variety of sensors (e.g., air temperature sensors (30), growth factor sensors (46a, 46b), and thermal sensors) and controlling associated actuators. While multiple microcontrollers may be used for specific subsystems, a single microcontroller is preferred to regulate all system functions. Key tasks performed by the microcontroller include: a) monitoring environmental conditions based on data from internal and external air temperature sensors (30) and adjusting vent cover positions (26) to regulate airflow and temperature; b) controlling nutrient fluid flow by receiving data from growth factor sensors (46a, 46b) and adjusting pump speed, nutrient flow rates, and depletion valve (47) positions to maintain optimal nutrient concentrations; c) regulating fluid temperature by receiving readings from thermal sensors and activating heating or cooling devices (H/C) to maintain nutrient fluid temperature within a predefined range. The microcontroller integrates all these functions into a single automated system, enhancing system efficiency and reducing the need for manual intervention.

Conduit: “Conduit” refers to any structure used to transport nutrient fluid or other fluids from one location to another within the hydroponic system. Conduits may take the form of pipes, tubing, or other passageways designed to carry fluid through the system. In the present invention, conduits (18, 39, 45) are used to transport nutrient fluid from the nutrient fluid reservoir (16) to the plant growth conduits (21), where it contacts plant roots, and from the plant growth area back to the reservoir or waste area (50) via the depletion valve (47). Conduits may also be equipped with sensors or control devices to regulate fluid flow or monitor fluid characteristics.

Level Sensor: This refers to a device used to monitor the fluid level in a reservoir or conduit. The level sensor (65) in the nutrient replenishment subsystem detects when the fluid in the nutrient fluid reservoir (16) falls below a preset threshold and sends a signal to the microcontroller (66) to activate the pump (62). Once the fluid level reaches an optimal level, the sensor deactivates the pump to prevent overfilling.

Depletion Valve: This refers to a valve (47) used to control the flow of nutrient fluid that has passed through the plant-growth area. Based on data received from the microcontroller (33), the depletion valve directs nutrient fluid either back to the nutrient fluid reservoir (16) or to a waste area (50) for water recovery. The valve's position is adjusted based on real-time nutrient fluid quality, as monitored by the growth factor sensors (46a, 46b).

Substantially: As used herein, the term “substantially” refers to a condition, value, or relationship that is within acceptable technical tolerances or minor deviations that do not materially affect system performance or the desired outcome. For example, when the nutrient mass delivery rate is described as “substantially constant,” small fluctuations that fall within the normal operating range of pumps, sensors, or control systems are included. Similarly, when parameters such as pH or temperature are described as being “substantially within” a range, the term encompasses values that remain within normal measurement or control tolerances sufficient to maintain plant health and proper system function. Unless otherwise indicated, “substantially” includes variations of up to +10%, or such other range as would be recognized by one of ordinary skill in the art as not materially altering the intended result.

Waste Area: The term “waste area” refers to a designated region where spent nutrient fluid is directed after passing through the plant-growth area. In the present invention, the waste area (50) is where the nutrient fluid is either disposed of or treated for water recovery using methods like solar distillation (see FIG. 5). This area ensures that excess or depleted fluid is removed efficiently, contributing to the overall water conservation system.

Growth Factor Sensor: This refers to sensors (46a, 46b) used to measure key parameters of nutrient fluid, such as electrical conductivity, pH, dissolved oxygen, and specific nutrient levels. These sensors monitor the nutrient fluid entering and exiting the plant-growth area, providing data to the microcontroller (33) to adjust nutrient flow rates, nutrient composition, and ensure optimal conditions for plant growth.

Thermal Sensor: As used herein “thermal sensor” refers to a sensor used to measure the temperature of nutrient fluid in a hydroponic system. The thermal sensor monitors the temperature of the nutrient fluid to ensure it remains within the optimal range for plant root-zone metabolism. In the present system, thermal sensors are integrated with the microcontroller (33) to activate heating or cooling devices (H/C) when nutrient fluid temperature falls outside the desired range (typically 65° F.-75° F.).

Air Temperature Sensor: As used herein an “air temperature sensor” refers to a sensor used to measure the air temperature both inside and outside of the hydroponic support structure. These sensors are part of the thermostat system (30) and provide real-time temperature data to the microcontroller (33), which adjusts vent covers (26) or activates fans (31) to regulate the internal environment. Air temperature sensors enable the system to anticipate temperature swings based on both internal and external conditions, improving energy efficiency and maintaining stable growing conditions.

### DETAILED DESCRIPTION OF THE INVENTION

### A. Support System

### Primary Structure and Materials

The hydroponic system includes a support structure (S1) that defines an inner enclosed space for plant growth (S3). The structure preferably comprises walls and a roof made from translucent polymeric panels (1), which transmit between 70% and 95% of sunlight while providing thermal insulation. The combined surface area of the walls and roof should preferably consist of at least 30% polymeric sheets, with preferred configurations comprising 50%, 70%, or 80% polymeric panels to optimize sunlight transmission and insulation. These panels are typically made of polycarbonate or similar materials, with a thermal conductivity ranging from 0.05 to 0.4 W/m·K.

The polymeric sheets or panels (1) used for the walls and roof of the support structure should be made from one or more materials selected from polycarbonate, polyethylene, ethylene tetrafluoroethylene, polymethyl methacrylate (PMMA), polyethylene terephthalate (PET), and their combinations. Polycarbonate is the preferred material due to its excellent light transmission and thermal insulating properties. These panels are preferably double-walled (see FIGS. 27, 28, and 29), with a space between the two sheets ranging from 0.25 to 5.0 inches. The space may be filled with translucent or transparent insulating materials, such as aerogels, insulating gases (e.g., carbon dioxide, argon, or nitrogen), phase change materials (e.g., paraffin wax, eutectic salts, fatty acids, or hydrated salts), or combinations thereof. This double-walled design improves energy efficiency by providing enhanced insulation, helping to maintain a stable internal temperature despite fluctuating external conditions.

As shown in FIGS. 1, 2A, and 2B, the main support structure (S1) comprises a rigid frame made from columns (8), which are anchored to a solid floor (e.g., concrete). The preferred materials for the frame are galvanized steel or aluminum alloys. Aluminum alloys are lightweight, corrosion-resistant, and capable of withstanding high wind loads, making them ideal for long-term exposure to harsh environmental conditions. Galvanized steel, while heavier, offers exceptional strength and durability, particularly in regions prone to strong winds or storms. Alternatively, composite materials such as fiberglass-reinforced plastics can be used due to their high strength-to-weight ratio and resistance to corrosion. These frame materials provide robust support for the translucent polymeric panels (1) and ensure the stability and durability of the structure in challenging environments.

Preferred support structures are those that maximize sunlight penetration from multiple angles, allowing plants to absorb light energy throughout the day as the sun changes position. These structures may include arched or domed roofs, as well as panels in the roof or sides that permit sunlight to pass through. Geodesic dome structures are also an effective option for ensuring optimal light transmission. The figures illustrate support structures with sides and a roof that are securely joined to the frame, creating an enclosed plant-growth space (S3) that is separate from the external environment. These structural designs help regulate internal temperature and light levels, supporting the controlled growing conditions necessary for efficient plant growth.

### Plant Growth Area

The plant growth area (52) is situated inside the enclosed space of the support structure, where it is exposed to sunlight and where plants can contact nutrient fluid. The area is designed with a fluid entry site (40) and a fluid exit site (44), forming part of the nutrient delivery subsystem (S4). Nutrient fluid flows from the reservoir (16) into the plant growth area, where it circulates around the plant roots to supply essential nutrients. The spent fluid then exits the plant growth area through the fluid exit site (44) and is either returned to the reservoir or directed to the waste area, depending on readings from the growth factor sensor (46) and control signals from the microcontroller (33).

Airflow within the support structure is regulated by one or more vents (3) equipped with movable covers (26) and insect screens (24) to allow for air exchange while preventing debris and pests from entering. A thermostat (30), which includes both internal and external air temperature sensors, measures the temperature differential (ΔT). The microcontroller (33) uses this data to open or close the vent covers to maintain a stable internal temperature. The system may also employ hysteresis or time-averaged algorithms to prevent rapid cycling of the vents. Fans (31) may be activated when passive venting is insufficient, providing additional airflow to regulate internal conditions.

### Size

The exact dimensions of the support structure are flexible, but the interior should be large enough to allow at least one person to work comfortably inside. Typical dimensions include a width of 15-30 feet, a length of 15 feet or longer, and a height ranging from 7 to 10 feet, with arched roofs potentially extending to 12 feet.

For geodesic domes, the minimum diameter is approximately 20 feet, providing about 305 square feet (28 square meters) of floor space and a height of 11.5 feet (3.5 meters). Larger domes can be used, with diameters up to 50 feet, which would provide nearly 2,000 square feet (185 square meters) of floor space. These dimensions provide ample space for plant growth while accommodating the hydroponic system components and ensuring efficient operation.

### B. Automation of Systems

The system utilizes a variety of sensors to monitor parameters such as air temperature, electrical conductivity (EC), pH, and nutrient fluid temperature. These sensors transmit data to the microcontroller (33), which processes the information and makes adjustments to the system to maintain optimal growing conditions.

Based on sensor input, the microcontroller can automatically control equipment such as turning pumps (15) on or off, adjusting pump speed, regulating the position of the depletion valve (47), and activating or deactivating actuators to move vent covers (26) or fans (31). It can also replenish low nutrient fluid levels by activating the nutrient replenishment subsystem (S6) or adjust temperature by controlling heating or cooling devices (H/C).

Communication between sensors, the microcontroller, and other devices can be achieved via either wired connections (e.g., I2C, SPI, UART) or wireless protocols (e.g., Wi-Fi, Bluetooth, Zigbee, LoRa). This automated control improves system efficiency, reduces the need for manual intervention, and ensures consistent environmental conditions for plant growth.

### C. Thermal Heating

Thermal regulation is a critical factor for the hydroponic support structure. Insulation is provided by materials such as double-walled polycarbonate panels, which help minimize heat loss and maintain stable internal temperatures. To further manage temperature fluctuations, the system may incorporate thermal mass elements within the structure, such as water supplies or concrete walls, that absorb heat during the day and release it at night. These elements help mitigate temperature extremes, ensuring a more stable growing environment for the plants.

Phase Change Materials (PCMs) may be incorporated into the system as an alternative or supplementary method of temperature regulation. These materials are designed to maintain a stable temperature in the 70-95° F. (18-35° C.) range, which is ideal for plant growth. PCMs can be integrated into insulated panels or placed in containers within the inner enclosed structure, where they absorb heat during the day and release it at night as temperatures drop, providing rapid thermal adjustment. This helps maintain a consistent internal environment. Examples of suitable PCMs include paraffin wax, eutectic salts, fatty acids, and hydrated salts such as sodium sulfate decahydrate, calcium chloride hexahydrate, and polyethylene glycol (PEG). By stabilizing temperature fluctuations, PCMs help reduce the load on other thermal control systems, such as fans or heating devices, improving overall energy efficiency.

### D. Temperature Control System

The hydroponic system includes a temperature control subsystem designed to regulate the internal temperature of the enclosed support structure. This subsystem incorporates vents (3, V1) for aeration and cooling. Each vent is equipped with movable covers (26) or sliding panels that can be opened or closed to allow airflow between the interior and exterior of the structure. The vent covers are controlled by the microcontroller (33), which adjusts them based on sensor data to maintain a stable internal temperature for optimal plant growth.

The temperature control subsystem is equipped with a thermostat (30) that monitors the temperature of the inner enclosed space (S3) and transmits data to the microcontroller (33). Based on the temperature readings from the thermostat and other air temperature sensors (30), the microcontroller adjusts the vent covers (26) and may also activate fans (31) to maintain the desired internal temperature. For example, when the temperature exceeds a preset threshold (e.g., 70° F.), the microcontroller opens the vents and may activate the fans to cool the space. Conversely, if the temperature falls below the desired range, the vents close, and fans are deactivated. The system can be configured to open or close the vents automatically based on temperature thresholds (e.g., open above 70° F., close below 70° F.) or by user-defined settings. The fans may also be activated independently of the vents when additional airflow is needed to regulate the temperature. This automation helps ensure a stable growing environment while minimizing the need for manual adjustments.

Alternatively, the thermostat may integrate an outdoor air sensor that measures the temperature of the environment outside the support structure. Using this data, the microcontroller (33) can automatically adjust the vents to optimize internal conditions. For example, the vents will remain open when the outdoor temperature is above 70° F. and close when the temperature drops below 70° F. or 75° F. This adaptive system helps maintain optimal conditions inside the support structure while reducing energy consumption by responding to external environmental changes.

Ideally, the system uses a smart thermostat that simultaneously measures both indoor and outdoor air temperatures using separate sensors, all integrated with the microcontroller (33). While smart thermostats are not commonly used in hydroponic systems, they are widely available for home and commercial applications. Examples include the Ecobee Smart Thermostat Premium® and the Honeywell Home Prestige® IAQ Kit with RedLINK®. These thermostats enable more precise environmental control by proactively adjusting the system based on real-time temperature data, improving energy efficiency and maintaining stable growing conditions.

Simultaneously measuring indoor and outdoor temperatures is particularly advantageous in environments with rapid temperature fluctuations. This capability allows the system to anticipate indoor temperature changes based on outdoor conditions, enabling proactive adjustments before indoor temperatures change substantially. For example, when overheating is detected, the microcontroller (33) can open vents and activate fans to cool the space, reducing plant stress. By knowing both the current external temperature and its rate of change, the system can fine-tune heating or cooling efforts more efficiently, helping to maintain stable growing conditions while reducing energy consumption and operational costs.

### E. Emergency Thermal Control System

Maintaining the nutrient fluid within an optimal temperature range is critical for plant health, as fluctuations outside the ideal range can slow plant metabolism, reduce nutrient absorption, and increase disease risk. In environments with large daily temperature swings, nutrient fluid temperatures may rapidly drop at night and rise during the day. While the internal airspace temperature is regulated through the use of vents (3), fans (31), and insulation, the nutrient fluid itself can still experience undesirable thermal variations. This is due to factors like thermal lag, ambient conduction through exposed pipes or components, and heat loss during nighttime cooling.

To address these thermal variations, the hydroponic system includes an emergency thermal regulation system designed to maintain the nutrient fluid temperature within a predefined optimal range, typically between 65° F. and 75° F. (18-24° C.). This system is not meant to replace the general environmental control mechanisms, such as ventilation and insulation, which regulate air temperature. Rather, it serves as a failsafe to ensure root-zone stability, particularly under conditions of thermal stress where rapid changes in external temperatures could otherwise compromise plant health. The system activates either heating or cooling mechanisms to regulate the temperature of the nutrient fluid, ensuring that plant roots remain within their ideal temperature range even when external conditions fluctuate dramatically.

In certain embodiments, the emergency thermal regulation system may include a submersible heater, such as a titanium immersion heater, commonly used in hydroponic or aquatic systems. Examples include commercially available heaters like the Hydrofarm Active Aqua Titanium Submersible Heater or the Inkbird ITC-308 system paired with a 300 W-1000 W aquarium heater. These heaters are compact, cost-effective, and widely available, making them ideal for applications where simplicity and affordability are priorities. The heaters are controlled by the microcontroller (33), which activates them when the nutrient fluid temperature falls outside the optimal range. This ensures the fluid remains at the ideal temperature for plant root-zone metabolism, even during extreme environmental conditions.

To regulate nutrient fluid temperature when it exceeds the optimal range, a cooling element is included in the system. Suitable options for cooling include compact aquarium chillers, such as the Active Aqua AACH10HP Hydroponic Chiller, which can be paired with a small pump to cool nutrient fluid in reservoirs up to 40 gallons. For smaller systems, an alternative is a passive radiator system with an inline fan or a thermoelectric cooling unit (Peltier-based). These systems, built using modular components like TEC1-12706 Peltier modules, a heat sink, and a 12V DC fan, are cost-effective and readily available. The cooling system is integrated into the overall temperature control subsystem, with the microcontroller (33) managing its activation based on real-time temperature data from the thermal sensor.

In some embodiments, a dual-function temperature control unit capable of both heating and cooling the nutrient fluid is used. For example, the Inkbird ITC-310T-B dual-stage temperature controller can independently regulate both a heater and a chiller based on sensor input, maintaining nutrient fluid temperature within a tight range without the need for complex programming or expensive hardware. More integrated systems, such as the EcoPlus Commercial Chiller with Heater, are also suitable for larger installations where precision and automation are prioritized. These systems can be seamlessly integrated with the microcontroller (33), which automates temperature adjustments based on real-time sensor data.

### Configurations

The thermal control components can be implemented in various configurations depending on system size and complexity. In one configuration, a submersible heating or cooling unit is placed directly in the nutrient fluid reservoir (16), where it is controlled by the microcontroller (33) based on temperature data from a thermal sensor. This setup is ideal for low-maintenance, space-constrained systems, such as small-scale or residential hydroponic installations.

Alternatively, a separate thermal loop can circulate fluid through an inline heater coil, cooling coil, or Peltier module before returning the fluid to the reservoir. The loop is controlled by a solenoid valve or pump, activated only when temperature correction is necessary. This configuration helps isolate the heating/cooling components from the primary nutrient delivery path, minimizing disruption to nutrient flow while maintaining efficient thermal control.

In both configurations, the microcontroller (33) processes data from temperature sensors (e.g., growth factor sensors (46a, 46b) or dedicated thermal sensors) and compares it to preset thresholds. When the temperature falls within the desired range, the microcontroller deactivates the thermal control system to conserve energy and reduce wear on the components.

### Microcontroller Integration and Control of Heaters/Coolers

To enable automated operation, the microcontroller (33) controls the heating and cooling components using electrical switching devices. Many commercially available heaters and chillers lack digital interfaces, but they can be managed by the microcontroller through standard relay modules, such as mechanical relays, solid-state relays (SSRs), or transistor switches. The microcontroller activates these relays based on temperature data from thermal sensors. When the temperature deviates from the optimal range, the microcontroller switches the heating or cooling devices on or off, ensuring precise control of nutrient fluid temperature.

In some configurations, a dual-stage temperature microcontroller (e.g., Inkbird ITC-310T-B) may be used to simplify integration. This device receives temperature input from a sensor and directly controls both a heater and a cooler through separate electrical outlets. The microcontroller (33) interfaces with such a device, providing setpoints via analog or digital input or by enabling/disabling the microcontroller through a master power relay. Alternatively, the microcontroller may directly control heating and cooling components using pulse-width modulation (PWM) or other programmable control schemes, especially when low-voltage DC components such as Peltier modules are used. This allows for fine-tuned control of nutrient fluid temperature, improving efficiency and system responsiveness.

These control architectures enable the thermal regulation system to be integrated into the same sensor-controller-actuator framework used for nutrient quality monitoring and flow routing. This integration supports fully automated environmental management within the hydroponic system, ensuring efficient operation and stability across multiple subsystems.

### F. Air Filters and Insect Control

To protect plants from pests such as small flying insects, caterpillars, and dust, fine mesh insect screens (24) cover vents (3) and other openings in the support structure. These screens, made from materials like metal or plastic, have a mesh size of 0.4-1 mm or a 20×20 mesh. The screens are typically attached to the inner surface of walls using adhesives, tacks, staples, or other secure methods.

Doors and panels may include gasket seals to prevent insects from entering through gaps. Insect traps can be placed inside the structure to capture any pests that enter. Additionally, non-toxic insect-repelling coatings may be applied around entry points to further deter pests, ensuring a clean and safe environment for plant growth.

### G. Nutrient Delivery

The nutrient delivery system includes several key components, as shown in FIG. 4. While the figure illustrates a system with only two plant-growth conduits (21), in practice, many more conduits are typically used to support larger plant growth areas. The primary components are as follows:

1. Nutrient Reservoir (16): This holds the nutrient solution that is circulated through the system. The reservoir is typically a tank or container (e.g., 20-100 liters) made from food-safe plastic, glass, ceramic, or similar materials. The reservoir has an outlet connected to the pump (15), which circulates the nutrient fluid through conduits (18, 39, 45) to the plant-growth area (52), where plants (14) are positioned with their roots submerged in the flowing nutrient solution. The reservoir also has an inlet that receives nutrient fluid after it has circulated through the plants.

The nutrient reservoir (16) is typically a tank or container (e.g., 20-100 liters) made from food-safe plastic, glass, ceramic, or similar materials. It has an outlet connected to the pump (15) for circulating the nutrient fluid through the system and an inlet that receives fluid after it has completed circulating through the plants.

2) Pump: The pump (15) in the nutrient delivery system circulates nutrient fluid through the system, ensuring it contacts the plant roots. The pump may be a submersible pump, external inline pump, or pressurized tank. For small-scale systems, a 12V DC diaphragm pump with an adjustable flow rate of 100-300 liters per hour is commonly used. The pump is controlled by the microcontroller (33), which adjusts its operation based on real-time sensor data, such as nutrient fluid level or required flow rate.

3) Plant Growth Conduits: Plant growth conduits are used to support plants and expose their roots to circulating nutrient fluid. In the current system, nutrient fluid flows through the conduits, allowing it to contact the plant roots for nutrient absorption. The conduits are integrated into the nutrient delivery subsystem (S4), and fluid flow is regulated by the pump (15) to ensure consistent delivery of nutrients to the plants. The plant growth conduits are designed to optimize fluid contact with the roots while providing structural support for the plant vessels.

4. Sensor for Nutrient Quality: The growth factor sensor (46a) is positioned to monitor the nutrient fluid after it exits the last plant growth conduit (21) and before it reaches the depletion valve (47). The sensor measures key parameters such as pH, electrical conductivity (EC), dissolved oxygen, and nutrient concentration to determine whether the nutrient fluid remains suitable for plant growth. Based on this data, the microcontroller (33) can adjust the flow rate or activate the depletion valve (47) to either direct fluid back to the nutrient fluid reservoir (16) or to the waste area (50) for water recovery.

The EC sensor provides an overall indication of nutrient strength by measuring the total concentration of dissolved salts in the fluid. While it does not identify specific nutrients, it gives a general overview of nutrient levels, which typically include macronutrients (e.g., nitrogen, phosphorus, potassium) and micronutrients (e.g., iron, zinc, manganese). If the EC is too low, it signals nutrient depletion; if too high, it suggests excess salts, which can harm plant roots. Although the EC sensor provides a broad view, more advanced systems may include additional sensors for specific ions (e.g., nitrate sensors).

The growth factor sensor is typically installed in inline sensor holders or T-fittings within the fluid delivery system. These sensors are compatible with commercially available microcontrollers that come preprogrammed with settings for monitoring pH, EC, and dissolved oxygen levels. Systems such as the Bluelab Guardian Monitor Connect, HydroLogic Stealth-RO150, and Growlink Hydroponic Controller offer user-friendly interfaces and can send alerts to mobile devices for real-time monitoring and adjustments to nutrient levels.

### H. Integration of Nutrient Delivery With System Components

As shown in FIG. 4, a conduit (45) connects the fluid exit site (44) of the plant growth area (52) to a depletion valve (47), which directs the nutrient fluid either to a waste area (50) or back to the nutrient fluid reservoir (16) via conduit (48). A growth factor sensor (46a) is positioned between the fluid exit site and the depletion valve, where it measures key fluid properties such as pH, dissolved oxygen, electrical conductivity (EC), and the concentration of specific nutrients.

The sensor sends this data to the microcontroller (51), which adjusts the position of the depletion valve and controls the pump (15) to regulate nutrient flow to the plants. A multi-parameter sensor that can simultaneously measure pH, dissolved oxygen, and EC is preferred for this application, ensuring accurate and real-time nutrient quality monitoring. For example, the S80 Series Sensors by Electro-Chemical Devices Inc. can be used for this purpose, providing reliable data for system adjustments.

When data from the growth factor sensor (46a) indicate that the nutrient fluid exiting the plant growth area (52) is no longer able to fully support plant growth, the microcontroller (33, 51) responds by maintaining a substantially constant nutrient mass delivery (QxC) to the roots, where Q represents flow rate and C represents nutrient concentration. If nutrient depletion persists, the microcontroller repositions the depletion valve (47) to divert the spent fluid through the waste conduit (49) to the waste area (50), where it can be processed by the water-recovery unit (53-57).

Once fresh nutrient fluid has been circulated through the system and sensor readings confirm that nutrient quality is restored, the microcontroller repositions the depletion valve (47) to route the fluid through the return conduit (48) back to the nutrient reservoir (16). Through this alternating control of flow paths, the system continuously maintains optimal nutrient conditions while conserving water and minimizing waste.

### I. Automated Nutrient Fluid Replenishment

In certain embodiments, the hydroponic system includes an automated nutrient fluid replenishment subsystem (S6) designed to restore nutrient fluid levels and maintain a target nutrient composition in the main reservoir (16). This subsystem draws water and nutrient concentrate from separate reservoirs and combines them in a controlled ratio before returning the mixed solution to the nutrient reservoir. The subsystem operates as part of the overall nutrient management system, complementing the nutrient delivery and depletion subsystems to ensure continuous and balanced nutrient availability for plant growth.

In operation, the system utilizes a level sensor, e.g., a float sensor (65), that is positioned in the nutrient fluid reservoir (16) to signal the microcontroller (66) when nutrient fluid is low. In response, the microcontroller (66) activates a pump (62), which draws fluid from both the water reservoir (57) and the reservoir with nutrient fluid concentrate (58). The rate at which these fluids flow is controlled by the replenishment valves (59) and (60).

The fluids from the reservoirs are fed by the pump (62) into a mixing chamber (63) and then directed through a conduit (73) to the nutrient fluid reservoir (16). Prior to entering the nutrient fluid reservoir (16), the fluid from the mixing chamber (63) passes the growth factor sensor (64) and this takes readings similar to those of the sensor (46) in the fluid delivery system shown in FIG. 4. The readings are sent to the microcontroller (66), which, based on this data, determines if adjustments are needed in the relative amounts of water and nutrient fluid concentrate. Adjustments are made by the microcontroller (66), changing the positions of the replenishment valves (59, 60).

The microcontroller will activate the pump (62) when the level sensor detects that reservoir volume has dropped below a preset lower threshold, and deactivates the pump when the level reaches an upper threshold. This dual-sensor feedback (level sensor and growth factor sensor) ensures both chemical and volumetric stability in the nutrient solution without manual intervention. The process continues until the nutrient fluid reservoir (16) has been replenished. At that point, the level sensor (65) provides the microcontroller (66) with data indicating that replenishment is complete, and the microcontroller turns off the pump (62).

The replenishment system may also optionally include a thermal sensor which determines the temperature of the nutrient fluid and transmits this to the microcontroller. Once received, the data from the thermal sensor is analyzed by the microcontroller to determine if it is within a preset range. If the temperature is not within the range, the microcontroller signals the heating/cooling to either heat or cool the nutrient fluid to bring in within the preset range. When this occurs, the microcontroller deactivates the the H/C system. The thermal sensor may either be a separate sensor or in may be a component of the growth factor sensor.

Many variations of this system should be apparent and are compatible with the current hydroponic system. For example, the pump (62) could be replaced by two pumps, one replacing replenishment valve (59) and the other replenishment valve (60). The microcontroller (66) could then adjust the speed of the pumps rather than the positions of the replenishment valves. Under these circumstances, the water and nutrient fluid concentrate could go directly into a mixing chamber. The invention encompasses this and similar variations.

### J. Water Recovery

Recovery from Waste Nutrient Fluid

The nutrient recirculation system sends spent nutrient fluid to a waste area, and from there, nutrient-depleted nutrient fluid may be sent to a storage container in or out of the hydroponic system. However, in environments where water is scarce, it is preferred that a procedure is used to recover water from the spent nutrient fluid. Numerous methods for effecting recovery are known in the art and could be adapted for use. These methods include: membrane filtration (reverse osmosis or nanofiltration); solar distillation; adsorption/desorption systems; biological treatment; and evaporative recovery systems.

A preferred system for the present hydroponic system is passive solar distillation because of its simplicity and low cost. However, recovery of water by membrane filtration is probably the most efficient option. In this, spent nutrient fluid is pushed through a semipermeable membrane that separates water from dissolved salts, nutrients, and contaminants. The membrane unit may comprise a reverse osmosis or nanofiltration membrane with fluid being fed through the membrane by a pump. Typically, the process includes a pre-filtration step in which fluid passes through a coarse filter to remove debris or large particles before entering the membrane unit.

### Rainwater Recovery

The hydroponic system described herein may also include a rainwater recovery system. In this, rainwater is collected from the roof of the hydroponic structure using rain gutters and downspouts. At the inlet of the downspouts, a debris filter is installed to remove large particles such as sand or dirt, ensuring that only clean rainwater flows into the storage reservoir. The collected rainwater is directed into a rainwater reservoir found either outside or, preferably, inside the inner enclosed space of the support structure. If desired, the system may incorporate a first flush diverter that removes the initial portion of rainwater, which may contain roof contaminants, before directing clean water into the reservoir.

### K. Stackable Plant Trays

FIG. 8 illustrates an embodiment of the invention in which multiple hydroponic modules are arranged in a vertically stackable configuration supported by a common framework. This embodiment allows the system to be expanded upward to increase plant density while maintaining uniform environmental conditions, nutrient delivery, and illumination.

A vertical frame (74) forms the primary structural support for the stacked assembly. The frame may include upright members joined by cross-braces or panels and is dimensioned to bear the combined weight of multiple modules, associated fluid reservoirs, and lighting components. The frame can also define internal channels or conduits that accommodate power cables, data wiring, and nutrient supply and return lines, thereby reducing external clutter and simplifying installation.

Mounted to the frame are a plurality of stackable plant-growth modules (75). Each module is a self-contained hydroponic unit having standardized mechanical, fluidic, and electrical interfaces that permit quick coupling to adjacent modules above and below. The modules may be manufactured as identical or interchangeable units so that additional levels can be added as required without redesigning the structure.

Each module includes a support surface (76) that provides both mechanical strength and illumination for the tier below. Embedded or attached grow-light assemblies within the support surface emit photosynthetically active radiation onto the plant-support surface (78) of the next lower module. The support surface may further incorporate reflective panels or heat-dissipation fins to distribute light evenly and manage temperature within the vertical column.

Fluidic and electrical interconnections between modules are made through quick-connect ports (77) positioned along the sides or rear of each unit. These ports may include seals and automatic shutoff valves that allow individual modules to be installed or removed without interrupting operation of the remaining stack. The ports also serve as alignment guides, ensuring that nutrient supply and return lines, as well as power and data pathways, are properly engaged.

The plant-support surface (78) defines the upper face of each module and supports the plant root zone and growth medium. The surface may include apertures or recesses for plant baskets, grooves or channels for nutrient distribution, and surface textures that promote aeration of the root zone. When stacked, the plant-support surfaces and underlying light assemblies cooperate to provide uniform illumination and nutrient exposure at each level.

Environmental parameters such as temperature, humidity, and nutrient composition may be controlled collectively by the same sensor and microcontroller network described for previous embodiments. Air circulation ducts or fans may be integrated within the vertical frame (74) to maintain even airflow and thermal balance across all tiers. In this way, the stackable-tray embodiment operates as a modular extension of the base hydroponic system, offering scalable vertical capacity while preserving uniform growth conditions and ease of maintenance.

### L. Power Supply

The hydroponic system may be powered by any source capable of providing sufficient electrical energy to operate its components, including pumps, microcontrollers, fans, sensors, and heating/cooling units. In most installations, alternating current (AC) from a standard electrical grid connection is used. However, the system can also operate on direct current (DC) supplied by batteries or a photovoltaic (solar) array. In certain embodiments, a hybrid configuration is employed in which solar panels charge a battery bank that delivers power to the system through an inverter or DC distribution circuit, allowing both on-grid and off-grid operation.

The power subsystem may include components such as a charge controller, inverter, and voltage regulator to maintain stable voltage levels for all devices. Low-voltage direct current (5-24V DC) typically powers the sensors and microcontroller, while higher voltages (110-240V AC) may be used for pumps, fans, and heating/cooling (H/C) devices. In battery-backed or off-grid configurations, the microcontroller (33) can monitor battery charge status and automatically enable or disable selected components to conserve power during low-energy conditions.

Energy efficiency may be improved through the use of variable-speed pumps and fans, LED grow lights, and optimized cycles for heating and cooling operations. The microcontroller may also execute energy management algorithms that log power consumption, predict demand patterns, and adjust operational timing to reduce peak loads. When integrated with solar or battery systems, this feature helps balance power generation and consumption, extending system autonomy and minimizing energy costs.

If solar panels are used, excess energy generated by the solar panels during the day is stored in a rechargeable battery unit, allowing for uninterrupted operation during nighttime or periods of reduced sunlight. Lithium-ion or lithium iron phosphate (LiFePO₄) batteries are employed due to their high energy density, extended cycle life, and minimal maintenance requirements. The battery system is sized to provide at least 12 hours of continuous operation, accommodating the energy demands of critical components such as pumps and automated vents. Integrated safety features, including overcharge and over-discharge protection, ensure reliable and safe operation, while thermal management safeguards the system against the high ambient temperatures typical of desert environments.

### M. Sustainability and Maintenance

To ensure long-term performance, materials may be treated for UV resistance to prevent degradation from intense sunlight. Anti-corrosion coatings may be applied to metal components to enhance durability. The structure may be designed modularly, allowing for easy replacement or expansion of individual sections as needed. Sensors may be installed to monitor environmental conditions, wind loads, and structural integrity, enabling proactive maintenance and efficient operation.

### N. System for Maintaining Oxygen Levels in Nutrient Fluid

In hydroponic systems, maintaining appropriate dissolved oxygen (DO) levels in the nutrient fluid is essential for healthy plant growth. Optimal DO concentrations typically range between 6 and 8 parts per million (ppm), ensuring that plant roots receive sufficient oxygen to support respiration, nutrient uptake, and cellular metabolism. Maintaining oxygen within this range promotes vigorous root development and prevents conditions such as root hypoxia and root rot, which can occur when oxygen levels fall below the desired range.

Oxygen levels may be maintained through aeration or oxygenation systems integrated into the nutrient fluid reservoir (16) or circulation loop. In one embodiment, an air pump supplies air to one or more diffusers or air stones located at the base of the reservoir, producing fine bubbles that dissolve oxygen efficiently throughout the fluid. The microcontroller (33) can regulate the air pump based on data from a dissolved oxygen sensor, maintaining DO within a preset range. In alternative embodiments, oxygen may be introduced through Venturi injectors, inline gas diffusers, or microporous membranes placed in the return conduit of the nutrient delivery system.

The DO control subsystem may operate continuously or in intervals based on oxygen concentration, temperature, and pump operation. By integrating the aeration components into the overall sensor-controller-actuator framework, the system ensures that oxygen levels remain stable, energy usage is optimized, and root health is preserved under varying environmental conditions.

### O. Automated Method of Operation

In operation, nutrient fluid is circulated from the nutrient fluid reservoir (16) through one or more plant growth conduits (21) in the plant-growth area (52) so that the fluid contacts plant roots and exits the plant-growth area. A growth factor sensor (46a) positioned in the return path measures one or more parameters of the exiting fluid, including pH, electrical conductivity (EC), dissolved oxygen (DO), temperature, and/or specific nutrient concentrations. The microcontroller (33, 51), responsive to the sensor data, regulates pump (15) speed and the position of a depletion valve (47) to maintain a substantially constant nutrient mass delivery rate (QxC) to the roots and to route fluid selectively to a return conduit (48) or to a waste conduit (49) leading to a waste area (50).

Internal and external air temperatures are measured by air temperature sensors associated with a thermostat (30). The microcontroller opens or closes movable vent covers (26) and may activate fans (31) to maintain internal air temperature substantially within a preset range. Control algorithms, such as hysteresis and time-averaging may be applied to reduce rapid cycling. In some embodiments, external temperature trends are additionally considered to anticipate and mitigate internal temperature overshoot.

When the level sensor (65) indicates that the nutrient reservoir (16) has fallen below a lower threshold, a replenishment subsystem (S6) is activated. Water from a water reservoir (57) and nutrient concentrate from a concentrate reservoir (58) are metered via replenishment valves (59, 60) or via two dedicated pumps and are blended in a mixing chamber (63). A growth factor sensor (64) downstream of the mixing chamber measures parameters of the mixed solution. The microcontroller (66) adjusts valve positions and/or pump speeds to achieve target composition and then directs the mixture to the reservoir (16) through conduit (73) until an upper threshold is reached, at which point the replenishment subsystem is deactivated.

Nutrient fluid temperature is regulated by a heating/cooling device (H/C) controlled by the microcontroller in response to a thermal sensor reading, which may be provided by a dedicated thermal sensor or by a temperature channel of a growth factor sensor. When temperature readings fall outside a preset range, the microcontroller activates the H/C device until nutrient fluid temperature returns substantially within the range, whereupon the device is deactivated.

In certain embodiments, dissolved oxygen in the nutrient reservoir (16) is maintained between about 6-8 ppm using an aeration subsystem comprising an air pump and diffuser(s) or alternative oxygenation components such as Venturi injectors or inline microporous diffusers. The aeration subsystem may operate continuously or in cycles under microcontroller control based on DO readings, fluid temperature, and/or circulation status.

Spent nutrient fluid routed to the waste area (50) can be treated by a water recovery subsystem (S5). In a preferred embodiment, passive solar distillation is employed: spent fluid is placed in a waste tray (53) exposed to sunlight, water vapor condenses on an inclined surface (54), and condensate is collected by a condensation gutter (55) and directed to a clean-water reservoir (57) for reuse.

### P. Method of Thermally Regulating Nutrient Fluid

The thermal control method begins by continuously monitoring the temperature of nutrient fluid within or adjacent to the nutrient reservoir (16) using one or more thermal sensors. The temperature data are transmitted to the microcontroller (33, 51), which compares the measured temperature to a preset target range (for example, 65° F.-75° F.). When the measured temperature falls outside this range, the microcontroller activates a heating/cooling (H/C) device to restore the nutrient fluid temperature substantially within the desired range.

Heating may be provided by a submersible heater such as a titanium immersion element, while cooling may be achieved through a compact chiller or thermoelectric (Peltier-based) module coupled to a heat sink and circulation loop. The microcontroller controls these devices via relay modules, mechanical relays, solid-state relays (SSRs), or transistor switches—that switch power to the heater or cooler. In some embodiments, pulse-width modulation (PWM) or an equivalent control scheme is used to vary output power for finer temperature regulation.

The thermal sensor may be an independent component or part of a multi-parameter growth factor sensor (46a or 64) that also measures electrical conductivity, pH, or dissolved oxygen. In some configurations, the microcontroller anticipates changes in nutrient fluid temperature based on data from indoor and outdoor air temperature sensors associated with the thermostat (30) and proactively activates heating or cooling to offset expected thermal drift.

In other embodiments, the H/C device is a dual-function temperature control unit capable of both heating and cooling, controlled by a dual-stage temperature microcontroller (e.g., Inkbird ITC-310T-B) interfaced with the microcontroller. The system may record temperature readings and activation cycles to maintain a performance log and predict maintenance needs. By automatically maintaining nutrient fluid temperature substantially within its optimal range, the method ensures consistent root-zone conditions, efficient energy use, and long-term system stability.

### Q. Method of Automated Nutrient Fluid Replenishment

The replenishment method begins when the level sensor (65) detects that the nutrient reservoir (16) has fallen below a preset lower threshold. The sensor transmits this information to the microcontroller (66), which activates a pump (62) to draw water from a water reservoir (57) and nutrient concentrate from a nutrient concentrate reservoir (58). Flow from each reservoir is controlled by independently actuated replenishment valves (59, 60) or by separate variable-speed pumps. The microcontroller regulates the relative proportions of water and concentrate according to stored mixture ratios that correspond to the growth stage of the plants or measured nutrient depletion.

The fluids are combined in a mixing chamber (63) to form a replenished nutrient solution, which passes through a conduit (73) toward the nutrient reservoir (16). Before entering the reservoir, the mixed fluid flows past a growth-factor sensor (64) that measures one or more properties of the replenished solution, such as pH, electrical conductivity (EC), temperature, and dissolved oxygen (DO). The sensor data are analyzed by the microcontroller, which adjusts the positions of the replenishment valves (59, 60) or the speeds of the pumps until the measured parameters fall substantially within preset target ranges.

The microcontroller also receives feedback from the level sensor (65) to track reservoir volume. When the fluid level reaches the upper threshold, the microcontroller closes the replenishment valves and deactivates the pump, completing the replenishment cycle. This dual-sensor feedback maintains both volumetric and chemical stability of the nutrient solution without manual intervention.

Optionally, the replenishment subsystem includes a thermal sensor to measure the temperature of the replenished nutrient fluid. The microcontroller compares the temperature to a preset range and, if necessary, activates the system's heating/cooling (H/C) device to bring the temperature substantially within the desired limits before the fluid is returned to the nutrient reservoir.

In alternative configurations, the single pump (62) may be replaced by two independent pumps corresponding to replenishment valves (59, 60), enabling mixture control through pump-speed modulation. Under such configurations, the water and nutrient concentrate streams may be directed directly into the mixing chamber (63). The microcontroller can log replenishment cycles, consumption rates, and sensor readings to estimate nutrient usage and optimize replenishment frequency. Communication among sensors, valves, and the microcontroller may occur via wired protocols such as I2C or SPI or via wireless connections such as Wi-Fi or LoRa.

By automating these operations, the method ensures that both the quantity and composition of nutrient fluid remain within desired limits, minimizing manual intervention while maintaining consistent nutrient availability for healthy plant growth.

### R. Adaptive Control

In another embodiment, adaptive control logic is implemented within the nutrient-circulation loop to maintain substantially uniform temperature and nutrient concentration throughout the system. As illustrated in FIGS. 4 and 6, sensors positioned before and after the plant-growth region (46a, 46b) provide continuous measurements of nutrient-fluid temperature and electrical conductivity (EC) as indicators of thermal load and ionic strength within the circulating solution. The microcontroller receives these signals and determines intra-loop differentials, such as a temperature differential between the supply and return conduits and an EC differential between the reservoir (16) and the return line.

The adaptive control rules described herein may be implemented as programmable instructions stored in non-volatile memory and executed by the microcontroller. The instructions may include conditional logic, proportional or integral adjustment algorithms, and stored calibration constants defining target ranges for temperature, electrical conductivity, and flow rate. In alternative embodiments, the control rules may be embodied in firmware, compiled software code, or discrete logic circuitry performing equivalent operations.

Based on these differentials, the microcontroller operates actuators, including the circulation pump (15), the temperature-conditioning device (H/C), and the splitter or depletion valve (47) that directs a controlled purge fraction either to waste or back to the reservoir. In systems that also incorporate the automated replenishment subsystem (S6), the same microcontroller may operate replenishment pump (62) and valves (59, 60) to adjust mixture ratios. Each actuator is driven according to stored control rules defining corrective actions in response to deviation of temperature or EC from a target range. Following each actuator operation, the microcontroller monitors subsequent sensor responses and automatically adjusts at least one rule parameter, such as H/C on-time, pump (15) speed, valve (47) positioning, or the valve (59/valve-60) mixing ratio to reduce residual error. Because actions taken at one location influence conditions elsewhere in the shared nutrient loop, the system self-tunes to maintain temperature and ionic-concentration stability with minimal waste and energy consumption.

By way of example, suppose sensor 46a (before the growth trays) reports nutrient-fluid temperature is 72° F. and sensor 46b (after the trays) reports 78° F., while the target differential (ΔT)≤3° F. A 6° F. rise triggers corrective response by the microcontroller. The microcontroller increases the operation of the chiller (H/C) by a defined increment and slightly raises pump (15) speed to improve circulation. It then records the resulting ΔT in the next cycle (e.g., after 5 minutes). If ΔT decreases only to 5° F., the microcontroller increases chiller operation again; if ΔT falls below 2° F., the microcontroller proportionally reduces H/C operating time. Within a few iterations, the microcontroller converges on the minimal H/C activation time and flow rate that maintain ΔT≈3±0.5° F., reducing energy use while improving thermal uniformity across the plant region.

As a second example, suppose that EC at the nutrient reservoir (16) is 1.8 mS/cm and EC at the return line (46b) is 1.3 mS/cm. The 0.5 mS/cm drop indicates nutrient uptake or dilution in the plant zone, where the target range is 1.8±0.2 mS/cm. The microcontroller opens replenishment valve (60) (nutrient-concentrate source) slightly longer than replenishment valve (59) (water source) while running pump (62) to inject replenishment fluid into reservoir (16). After mixing, the upstream sensor (64) reports EC=1.7 mS/cm, close but still low. The microcontroller records the proportional response and applies it in the next cycle, adjusting valve (60) open time to reach the target more precisely.

The adaptive framework may also incorporate data from the thermostat (30), which provides both internal and external air-temperature readings. The microcontroller uses this information, together with nutrient-loop measurements from sensors 46a, 46b, and 64, to determine a composite deviation metric representing combined air- and nutrient-side departures from target conditions. The microcontroller then coordinates air-side actuators (vents 28 and fans 20) with nutrient-side actuators (H/C, pump (15), valve (47), and replenishment valves (59) and 60) to reduce the composite deviation. Following each adjustment, the microcontroller evaluates subsequent sensor responses and adaptively modifies one or more parameters, such as H/C on time, pump (15) speed, vent opening, fan speed, valve (47) positioning, or the valve (59)/valve (60) mixing ratio to minimize overshoot and energy use.

The composite deviation referenced herein may be determined mathematically as a weighted combination of multiple sensed parameters. For example, the microcontroller may compute a composite value equal to a weighted sum or ratio of (a) the difference between indoor and outdoor air temperatures and (b) the difference between nutrient-supply and nutrient-return temperatures. Weighting factors may be preset or adaptively updated to emphasize whichever variable most strongly affects plant-root temperature.

In this configuration, air-side changes that alter the nutrient heat load are anticipated and buffered by nutrient-side adjustments, while those nutrient-side actions in turn reduce the magnitude and rate of subsequent air-side corrections. For example, the microcontroller may increase H/C operating time and circulation-pump speed in anticipation of a rising outside-air temperature while incrementally opening vents (28), and then reduce H/C activation time once the measured supply-to-return temperature differential falls below the threshold.

During periods of high evaporative demand, identified when indoor-air temperature rises and reservoir level decreases faster than expected, the microcontroller can temporarily reduce purge flow through valve 47 and adjust replenishment ratios to maintain water balance. In this way, adaptive control maintains stable environmental and nutrient conditions, compensates automatically for both external weather fluctuations and internal plant-driven changes, and sustains efficient growth with minimal operator input.

For maintenance or safety purposes, manual override or default control may be provided. In such modes, the microcontroller may place the actuators in a predefined safe state or allow a user to operate vents, pumps, or valves directly through hardware switches or a local interface if sensor data become unavailable or fall outside credible ranges. This ensures continued operation and protects plant material in the event of sensor or communication failure.

All references cited herein are fully incorporated by reference. Having now fully described the invention, it will be understood by one of skill in the art that the invention may be performed within a broad and equivalent range of conditions, parameters and the like, without affecting the spirit or scope of the invention or any embodiment thereof.

1-86. (canceled)

87. A hydroponic system suitable for arid environments having large diurnal temperature fluctuations, comprising:
(a) a support structure (S1, S2A, S2B) enclosing a plant-growth area (52);
(b) a nutrient-delivery subsystem comprising:
(i) a nutrient fluid reservoir (16);
(ii) a circulation pump (15);
(iii) conduits for delivering nutrient fluid from the nutrient fluid reservoir to the plant-growth area (36, 39) and for receiving nutrient fluid exiting the plant-growth area (45);
(iv) a first growth factor sensor (46b) positioned to measure one or more growth-promoting properties of nutrient fluid exiting the nutrient fluid reservoir and prior to entering the plant-growth area (52);
(v) a second growth factor sensor (46a) positioned to measure corresponding fluid parameters of nutrient fluid exiting the plant-growth area (52); and
(vi) a depletion valve (47) configured to selectively route nutrient fluid exiting the plant-growth area (52) either to a return conduit (48) leading to the nutrient fluid reservoir (16) or to a waste conduit (49) leading to a waste area (50);
(c) a water recovery subsystem (S5) configured to receive nutrient fluid routed through the waste conduit (49), recover water therefrom, and store recovered water in a water reservoir (57);
(d) a nutrient fluid replenishment subsystem (S6) comprising:
(i) the water reservoir for storing recovered water (57);
(ii) a nutrient fluid concentrate reservoir (58);
(iii) a manifold (61) fluidically connected to the water reservoir (57) and the nutrient fluid concentrate reservoir (58);
(iv) a first replenishment valve (59) located between the water reservoir (57) and the manifold (61);
(v) a second replenishment valve (60) located between the nutrient fluid concentrate reservoir (58) and the manifold (61);
(vi) a replenishment pump (62) fluidically connected to the manifold (61);
(vii) a mixing chamber (63) located downstream of the replenishment pump;
(viii) a third growth factor sensor (64) positioned after the mixing chamber (63) and before the nutrient fluid reservoir (16); and
(ix) a level sensor (65) positioned to measure an amount of nutrient fluid in the nutrient fluid reservoir (16); and
(e) one or more microcontrollers (33, 51, 66) configured to:
(i) receive first data from the first growth factor sensor (46b) and second data from the second growth factor sensor (46a), and compare the first data and the second data to assess a decline in nutrient fluid effectiveness for supporting plant growth;
(ii) control the depletion valve (47) to route nutrient fluid to the nutrient fluid reservoir (16) when the compared first data and second data indicate acceptable nutrient fluid effectiveness, and to route nutrient fluid to the waste area (50) when the compared first data and second data indicate a decline in nutrient fluid effectiveness;
(iii) receive data from the level sensor (65), activate the replenishment pump (62) when the amount of nutrient fluid in the nutrient fluid reservoir (16) reaches or falls below a preset lower volume, and deactivate the replenishment pump (62) when the amount of nutrient fluid in the nutrient fluid reservoir (16) reaches or exceeds a preset upper volume; and
(iv) receive data from the third growth factor sensor (64) and adjust relative amounts of recovered water and nutrient fluid concentrate combined in the mixing chamber (63) by adjusting positions of the first replenishment valve (59) and the second replenishment valve (60;
wherein recovered water stored in the water reservoir (57) is used by the nutrient fluid replenishment subsystem (S6) to replenish the nutrient fluid reservoir (16); and
wherein the one or more microcontrollers (33, 51, 66) comprise either a single microcontroller configured to perform the recited functions or a plurality of microcontrollers collectively configured to perform the recited functions.

88. The hydroponic system of claim 87, wherein water is recovered from nutrient fluid routed to the waste area (50) by passive solar distillation and the recovered water is directed to the water reservoir (57) of the nutrient fluid replenishment subsystem (S6).

89. The hydroponic system of claim 88, wherein the water recovery subsystem (S5) comprises a waste tray (53) configured to receive nutrient fluid routed to the waste area (50), an inclined condensation panel (54) positioned to receive vapor from nutrient fluid in the waste tray (53), a condensation gutter (55), and a conduit (56) directing condensate to the water reservoir (57) of the nutrient fluid replenishment subsystem (S6).

90. The hydroponic system of claim 89, wherein the waste tray (53) is positioned to receive direct sunlight and the condensation panel (54) is inclined to direct condensate into the condensation gutter (55).

91. The hydroponic system of claim 87, wherein the mixing chamber (63) comprises one or more static mixers configured to homogenize recovered water and nutrient fluid concentrate before mixed fluid passes the third growth factor sensor (64).

92. The hydroponic system of claim 87, wherein the third growth factor sensor (64) is configured to measure one or more of electrical conductivity, pH, dissolved oxygen, or temperature of fluid exiting the mixing chamber.

93. The hydroponic system of claim 87, wherein the first growth factor sensor (46b) and the second growth factor sensor (46a) are configured to measure one or more of electrical conductivity, pH, dissolved oxygen, and concentration of one or more nutrients.

94. The hydroponic system of claim 87, wherein either:
(i) at least one of the first growth factor sensor (46b) and the second growth factor sensor (46a) also measures nutrient fluid temperature and transmits temperature data to the one or more microcontrollers; or
(ii) the hydroponic system further comprises a separate thermal sensor configured to measure the nutrient fluid temperature (64) and transmit temperature data to the one or more microcontrollers.

95. The hydroponic system of claim 87, wherein the one or more microcontrollers (33, 51, 66) are further configured to adjust speed of the circulation pump (15) to maintain a substantially constant nutrient mass delivery rate, Q×C, wherein Q is volumetric flow rate and C is nutrient concentration.

96. A hydroponic system comprising:
(a) a nutrient fluid reservoir (16);
(b) vertically stacked plant-growth modules (75) having quick-connect ports (77) that fluidically couple adjacent modules;
(c) a depletion valve (47) fluidically connected to at least one of the vertically stacked plant-growth modules, to the nutrient fluid reservoir (16), and to a waste-water recovery area (S5);
(d) a first growth factor sensor positioned between said at least one vertically stacked plant-growth modules and the depletion valve (47), the first growth factor sensor being configured to measure one or more nutrient fluid characteristics and transmit corresponding signals to one or more microcontrollers;
(e) a water reservoir (57) fluidically connected to the waste-water recovery area (S5);
(f) a nutrient fluid concentrate reservoir (58);
(g) a manifold (61) fluidically connected to the water reservoir (57) and to the nutrient fluid concentrate reservoir (58);
(h) a pump (62) and a mixing chamber (63) located between the manifold (61) and the nutrient fluid reservoir (16);
(i) a second growth factor sensor (64) positioned between the mixing chamber (63) and the nutrient fluid reservoir (16); and
(j) the one or more microcontrollers being configured:
(i) in response to signals from the first growth factor sensor, to control the depletion valve (47) so as to direct nutrient fluid either to the nutrient fluid reservoir (16) or to the waste-water recovery area (S5); and
(ii) in response to signals from the second growth factor sensor (64), to control replenishment of nutrient fluid from the water reservoir (57) and the nutrient fluid concentrate reservoir (58) to the nutrient fluid reservoir (16).

97. The hydroponic system of claim 96, wherein, between the water reservoir (57) and the manifold (61) there is a first replenishment valve (59) and between the nutrient fluid concentrate reservoir (58) and the manifold there is a second replenishment valve (60).

98. The hydroponic system of claim 96, wherein the growth factor sensors measure pH, EC, and/or dissolved oxygen.

99. The hydroponic system of claim 96, wherein the nutrient fluid reservoir comprises a fluid level sensor (65) configured to send signals to the one or more microcontrollers regarding fluid level, and, in response to said signals the microcontroller is configured to send signals to the pump (62) which activate the pump, deactivate the pump, or change the pump's speed.

100. The hydroponic system of claim 96, wherein the quick-connect ports (77) include sealing elements and alignment features.

101. The hydroponic system of claim 96, wherein each of the vertically stacked plant-growth modules (75) is a self-contained hydroponic unit having standardized mechanical, fluidic, and electrical connection points.

102. The hydroponic system of claim 96, wherein the mixing chamber (63) contains one or more static mixers.

103. The hydroponic system of claim 97, wherein the first replenishment valve (59) and the second replenishment valve (60) are under control of the one or more microcontrollers and regulate flow rates of water and nutrient fluid concentrate to the manifold (61).

104. The hydroponic system of claim 99, wherein the microcontroller activates the pump (62) when fluid level in the nutrient fluid reservoir (16) drops below a preset lower threshold and deactivates the pump when the fluid level reaches a preset upper threshold.

105. The hydroponic system of claim 96, wherein water is recovered from nutrient fluid routed to the waste-water recovery area (S5) by passive solar distillation and directed to the water reservoir (57).

106. The hydroponic system of claim 96, wherein the waste-water recovery area (S5) comprises a membrane filtration system including a reverse osmosis membrane or a nanofiltration membrane.
